SEQUENCE LISTING (5 sequences)

SEQ ID NO: 1 - DNA, 2815 bp, Penicillium chrysogenum
tatccaaaattaactagttaactatacggagtatgcacagaaggattcaatttcaacagactgggctgaatgaaggccccacctctctgacatgtaatctcggattttaacacaggcacacccacggagttggttattcctcccagataggataccggtgcacggaagttagtatgaagatagtttgaccggttccaggcaccgactcgccaagatgtgcagaactttatttcctgcagatcagccggtagattctattccgtgaaactgacgattgatatcgcacccctattgcaccataccacgtgttgtaaccgggatcgtagagccctccgtgggtattgttcaagcattcgtgattcggtatcggtatagtatcaacgtagaagacgcaattattacgaatatatatattggatgcttccgatcgtcatttcatgtacaccaacctattcctttcctttcgttcctttgtacattgccctccgggctatcctcattatgaagtccactattatcacctccattctcttctctgtggctgccgtccaggcctatagcccggccgagcagatcgacgtccagtctcacctgctttctgaccccaccaaggtcgagggagagacttacgactatgtcattgctggtggtggtttgactggtctgaccgtggctgccaagctgtctgaaaacccgaagatcaaagtccttgtgattgagaagggattctacgaatccaacgatggaccgatcatcgaggaccccaacgcctatggggagatctttggaactagtgtggatcagaattatctcacagttcccctcatcaacaaccgaactggggaaattaagtctggcctcggtcttggtggctcgaccttgatcaacggcgattcctggacccgccccgacaaggtccagatcgactcatgggaaaaggtctttggcatggagggctggaactgggacaatgtcttccagtacatgcagaaagctgagcgctcgcgccccccgactgccgcccagattgaagccggtcacttctacgaccctgcctgtcatggaacagacggaaccgttcatgccggccctcgcgacaacggcaagccttggtccccactgatgcgagccctcatgaacaccgtctccgctttcggtgtccccgtccagaaggacttccactgcggtcacccccgtggtgtctcgatgatcccgaacaacctccatgagaaccagatccgggctgatgccgctcgcgaatggcttcttcccaactaccagcgcgataacctgcagatcctgactggccagaaggtcggaaaggttttgttcaaccagaccgcatctggacctaaggctgttggtgtgaacttcggtaccaacaaggctgttaacttcaatgtctacgccaagcaagaagttctgttggccgccggatctgccatttctcctttgatccttgaatactccggtattggtatcaagtccgtccttgacaaggccggtgttaagcagctcctcgaactccctgttggtctcaacatgcaagaccagaccactaccactgttcggtcccgcgccaacaacgcacctggacaaggccaggccgcttactttgccaacttcaccgaggttctcggcgaccacgccgcccagggtattaagttgctggacaccaagcttgaccagtgggccgaggagaccgttgcccgcggtggcttccacaatgtgactgccctcaagatccagtatgagaactaccgtaactggctccttgatgaggacgttgcatttgccgagctcttcttcgacactgagggcaagatcaactttgatatctggaatcttatccccttcactcgcggttccgtccacatcctcagcagtgacccttacctctggcaatacgcaaatgaccccaagttcttcatgaacgagctggatcttctcggccaggccgctgctactaagctgggtcgtgagctctctagcgctggtgagatgaagaagtactacgctggcgagaccatccccggcgacaacctgccccaggatgccaccgtcgagcagtgggaggactacgtgatgatgaacttccgtcctaactggcacgctgttagcacctgctctatgatgtcccgcgagcttggtggtgtcgtcgacgctactgccaaggtctacggtactcagggcctccgtgtcattgacggatctatccctcccactcaggtgtcctctcacgttatgaccgttttctacggtatggccttgcggatcgccgaatccgtccttgaagactatgccaagaaagcttagttggattactttgcgatgatcattttggcaaaagacagatttggtcgatcatcccgacagtgggaaatttgttcccccttttggatttgcgaggggactccgcactcaataatgtcctgactttgattggaagttagctattcctgccccgttccttgttattctctttgttattctctttctcgtgtatacaggttcatactacagttatagatttaagatttttagatagaaaatatatataaaaaaaataggggcagcaaacgaaatttctaagtaggaaagtgttgaacacgcggtaaacagatagtgttatttcataatttagcaagctgccagtaagttagccccagtggactcggtagtagaatatacactacctaagctagctagcgcgccagtacctcgactgtggtatgccagtagccaatcagcagcttatttaattaccctattcgcagcacgtgggcaatccttcaaacccaaatgacatggcgga

SEQ ID NO: 2 - DNA, 1815 bp, Penicillium chrysogenum
atgaagtccactattatcacctccattctcttctctgtggctgccgtccaggcctatagcccggccgagcagatcgacgtccagtctcacctgctttctgaccccaccaaggtcgagggagagacttacgactatgtcattgctggtggtggtttgactggtctgaccgtggctgccaagctgtctgaaaacccgaagatcaaagtccttgtgattgagaagggattctacgaatccaacgatggaccgatcatcgaggaccccaacgcctatggggagatctttggaactagtgtggatcagaattatctcacagttcccctcatcaacaaccgaactggggaaattaagtctggcctcggtcttggtggctcgaccttgatcaacggcgattcctggacccgccccgacaaggtccagatcgactcatgggaaaaggtctttggcatggagggctggaactgggacaatgtcttccagtacatgcagaaagctgagcgctcgcgccccccgactgccgcccagattgaagccggtcacttctacgaccctgcctgtcatggaacagacggaaccgttcatgccggccctcgcgacaacggcaagccttggtccccactgatgcgagccctcatgaacaccgtctccgctttcggtgtccccgtccagaaggacttccactgcggtcacccccgtggtgtctcgatgatcccgaacaacctccatgagaaccagatccgggctgatgccgctcgcgaatggcttcttcccaactaccagcgcgataacctgcagatcctgactggccagaaggtcggaaaggttttgttcaaccagaccgcatctggacctaaggctgttggtgtgaacttcggtaccaacaaggctgttaacttcaatgtctacgccaagcaagaagttctgttggccgccggatctgccatttctcctttgatccttgaatactccggtattggtatcaagtccgtccttgacaaggccggtgttaagcagctcctcgaactccctgttggtctcaacatgcaagaccagaccactaccactgttcggtcccgcgccaacaacgcacctggacaaggccaggccgcttactttgccaacttcaccgaggttctcggcgaccacgccgcccagggtattaagttgctggacaccaagcttgaccagtgggccgaggagaccgttgcccgcggtggcttccacaatgtgactgccctcaagatccagtatgagaactaccgtaactggctccttgatgaggacgttgcatttgccgagctcttcttcgacactgagggcaagatcaactttgatatctggaatcttatccccttcactcgcggttccgtccacatcctcagcagtgacccttacctctggcaatacgcaaatgaccccaagttcttcatgaacgagctggatcttctcggccaggccgctgctactaagctgggtcgtgagctctctagcgctggtgagatgaagaagtactacgctggcgagaccatccccggcgacaacctgccccaggatgccaccgtcgagcagtgggaggactacgtgatgatgaacttccgtcctaactggcacgctgttagcacctgctctatgatgtcccgcgagcttggtggtgtcgtcgacgctactgccaaggtctacggtactcagggcctccgtgtcattgacggatctatccctcccactcaggtgtcctctcacgttatgaccgttttctacggtatggccttgcggatcgccgaatccgtccttgaagactatgccaagaaagcttag

SEQ ID NO: 3 - protein, 604 aa, Penicillium chrysogenum
MKSTIITSILFSVAAVQAYSPAEQIDVQSHLLSDPTKVEGETYDYVIAGGGLTGLTVAAKLSENPKIKVLVIEKGFYESNDGPIIEDPNAYGEIFGTSVDQNYLTVPLINNRTGEIKSGLGLGGSTLINGDSWTRPDKVQIDSWEKVFGMEGWNWDNVFQYMQKAERSRPPTAAQIEAGHFYDPACHGTDGTVHAGPRDNGKPWSPLMRALMNTVSAFGVPVQKDFHCGHPRGVSMIPNNLHENQIRADAAREWLLPNYQRDNLQILTGQKVGKVLFNQTASGPKAVGVNFGTNKAVNFNVYAKQEVLLAAGSAISPLILEYSGIGIKSVLDKAGVKQLLELPVGLNMQDQTTTTVRSRANNAPGQGQAAYFANFTEVLGDHAAQGIKLLDTKLDQWAEETVARGGFHNVTALKIQYENYRNWLLDEDVAFAELFFDTEGKINFDIWNLIPFTRGSVHILSSDPYLWQYANDPKFFMNELDLLGQAAATKLGRELSSAGEMKKYYAGETIPGDNLPQDATVEQWEDYVMMNFRPNWHAVSTCSMMSRELGGVVDATAKVYGTQGLRVIDGSIPPTQVSSHVMTVFYGMALRIAESVLEDYAKKA

SEQ ID NO: 4 - DNA, 46 bp, Artificial
  primer
cccttaattaactcataggcatcatgaagtccactattatcacctc

SEQ ID NO: 5 - DNA, 32 bp, Artificial
  primer
ttaggcgcgcccactgtcgggatgatcgacca

(19) United States
(12) Patent Application Publication
(10) Pub. No.: US 2011/0091599 A1
(43) Pub. Date: Apr. 21, 2011

(54) METHOD FOR PREPARING NOODLES DOUGH WITH OXIDASE

(76) Inventors: Hugo Streekstra, Amsterdam (NL); Petrus Jacobus Theodorus Dekker, Den Haag (NL)

(21) Appl. No.: 12/988,928

(22) PCT Filed: Apr. 24, 2009
(86) PCT No.: PCT/EP09/54963

§ 371 Date: Oct. 21, 2010

(30) Foreign Application Priority Data
Apr. 24, 2008 (EP) 08155088.1

(51) Int. Cl. A21D 8/04; A21D 10/00; A23L 1/16; A23L 1/162

(52) U.S. Cl. 426/10; 426/18; 426/549; 426/557

(57) ABSTRACT

The present invention relates to a method for preparing dough. Particularly the invention relates to a method for producing dough that can be processed via sheeting (i.e. a sheetable dough). Even more particular, the invention relates to a method for manufacturing sheetable dough with a water addition level which level would normally result in a dough which can not be processed because it is too sticky. The present invention provides a method for preparing sheetable dough comprising adding an amount of water and an effective amount of oxidase to flour and wherein said amount of water in the absence of said oxidase results in a dough that can not be processed due to its stickiness.

### FIELD OF THE INVENTION

The present invention relates to a method for preparing dough. Particularly the invention relates to a method for producing dough that can be processed via sheeting (i.e. a sheetable dough). Even more particularly, the invention relates to a method for manufacturing sheetable dough with a water addition level which level would normally result in a dough which can not be processed because it is too sticky. The invention further provides dough obtainable according to a method of the invention as well as dough comprising products such as (asian) noodles or wrappings.

### BACKGROUND OF THE INVENTION

Asian noodles are different from pasta products in ingredients used, the processes involved and their consumption pattern. Pasta is made from semolina (coarse flour usually milled from durum wheat) and water, and extruded through a metal die under pressure. After cooking, pasta is often eaten with sauces. Asian noodles are characterised by thin strips from sheeted dough that has been made from flour (hard and soft wheats), water and salt. Eggs can be added to each product to give a firmer structure.

Asian noodles can be classified based on for example raw material, based on the salt used, based on size or based on the used processing.

Based on the absence or presence of alkaline salt in the formula, noodles can be classified as white (containing salt) or yellow (containing alkaline salt) noodles.

Noodles can also be classified based on the used processing, such as fresh, dried, boiled or steamed.

The basic processing steps for machine-made as well as hand-made noodles are:
mixing of raw materials
resting the crumbly dough,
sheeting the dough into two dough sheets,
compounding the two sheets into one,
gradually sheeting the dough sheets into a specified thickness and slitting into noodle strands.

After these steps the noodles are further processed by for example waving, steaming, (par)boiling, rinsing, draining or drying (for example air-drying or fry-drying).

In the mixing step, the ingredients such as flour, water, salt and other optional ingredients are processed into crumbly dough with small and uniform particle sizes. Higher water addition levels are associated with a number of desirable properties, such as smoothness and uniformity of the dough crumbs and subsequent sheets. However, there is a limit to the amount of water that can be added to the dough, because dough with a too higher water addition level becomes too sticky to be processed.

After mixing, the dough pieces are rested for 20-40 minutes before compounding. Dough resting helps water penetrate into dough particles evenly, resulting in a smoother and less streaky dough after sheeting.

The rested, crumbly dough pieces are typically divided into two portions, each passing through a pair of sheeting rolls to form a noodle dough sheet. The two sheets are then combined (compounded) and passed through a second set of sheeting rolls to form a single sheet.

Further dough sheeting is done on a series of 4-6 pairs of rolls with decreasing roll gaps. Noodle slitting is done by a cutting machine. The sheet is cut into noodle strands of desired width with a slitter. Noodles can be either square or round in shape by using various slitters. The noodles making process is now complete for some types of noodles. Noodles strands are cut into a desired length by a cutter. For making instant noodles, the noodle strands are waved before steaming and cutting.

Machine-made noodles typically score worse for features like viscoelasticity, smoothness, taste and others because the use of a machine limits the amount of added water.

As described above, the water addition level of noodles dough is low because otherwise it becomes sticky to process in the sheeting stage.

There is clearly a need for a process of preparing dough (and subsequent products like noodles or wrappings) which can be produced by a machine and which dough has increased water content.

The goal of the present application is to increase the amount of water in noodles dough without losing processability.

The present invention provides methods and means for increasing the amount of water in especially machine-made dough (and products derived thereof) essentially without negatively effecting the machinability of said dough.

Surprisingly, we have found that upon use of an oxidase in dough preparation and processing, it is possible to increase the amount of water in dough and at the same time keep the desired processability. The use of higher water addition levels leads to a better mixing, a better sheeting and in general to a more homogenous dough. The noodles or wrappings prepared from the resulting dough have improved elasticity and smoothness.

The use of glucose oxidase (which is one example of an oxidase) in noodle applications is known for a considerable period of time.

For example, CN 1788604 (also published as CN100334969C) describes multiple special corn flour compositions in which the refined corn flour is obtained via zymolysis of corn with protease and glucose oxidase. This results in so-called refined corn flour. The refined corn flour is subsequently used in the preparation of special corn flour for Chinese dumpling which composition comprises 0.00005-0.0001 glucose oxidase (mass ratio). This document does not relate to wheat flour and neither to noodle dough sheeting processability upon increased water absorption. The corn flour is fortified by wheat gluten to improve the properties of the flour. Furthermore, glucose oxidase is added to improve the functionality of the added gluten (production of cross links), i.e. CN 1788604 describes the use of glucose oxidase as a flour-strengthening agent.

Another example is CN 1759690A. This document describes that the synergistic effect of glucose oxidase, sodium caseinate and sodium carboxymethyl cellulose can be used to prepare noodles characterized by smooth surface, smooth taste, ease of cooking, no break off and less paste in soup. The defined goal is to provide a compound enzyme modifier for specialized noodle flour so as to improve steaming and cooking quality as well as nutrition of the noodles. There is no disclosure in respect of the dough qualities, let alone of the possibility to increase the water content of the dough. This document also refers to the use of glucose oxidase for fortifying the network structure of gluten. There is no disclosure that an oxidase can be used to increase the water absorption level of dough.

A further example is a publication from Feng Wenrui (Application of glucose oxidase in noodle processing, Science and technology of food industry, volume 21, number 6, 2000, pages 67-68). This document describes that some of the dough's rheological properties (max tensile strength, extensibility and energy) improve upon the addition of glucose oxidase (Table 1). All examples refer to a water content of 33 to 34%, which are considered to be a normal (i.e. not increased) water contents. This document does not describe the effect of an increased water content and glucose oxidase.

The inventors of the current invention have surprisingly found that glucose oxidase can be used to increase the amount of water during dough preparation and at the same time maintain an acceptable processability of the dough.

### DESCRIPTION OF THE FIGURES

FIG. 1 is a schematic representation of the cloning of the ZGL Peniclillium glucose oxidase gene in Aspergillus expression vector pGBFIN-5, resulting in pGBFINZGL.

FIG. 2 shows a Coomassie stain of an SDS-PAGE analysis of supernatant of a culture after 5 days growth of pGBFINZGL.

FIG. 3 shows ZGL expression (NuPAGE 4-12% Bis-Tris Gel) in ZGL transformant #1 culture filtrate after three days of cultivation.

FIG. 4 shows the purity of a pooled sample of ZGL after purification (NuPAGE 4-12% Bis-Tris Gel).

FIG. 5 shows the pH-dependency of ZGL activity

FIG. 6 shows the temperature-dependency of ZGL activity

### DESCRIPTION OF SEQUENCES

SEQ ID NO: 1 genomic PenGOX sequence

SEQ ID NO: 2 coding sequence PenGOX

SEQ ID NO: 3 protein sequence PenGOX

SEQ ID NO: 4 and 5 primer sequences

### DETAILED DESCRIPTION OF THE INVENTION

The present invention provides a method for preparing sheetable dough comprising adding an amount of water and an effective amount of oxidase to flour and wherein said amount of water in the absence of said oxidase results in a dough that can not be processed due to its stickiness.

The term “sheetable dough” is used to refer to dough which can be processed by a sheeting machine. The terms “sheetable dough”, “machine processable dough”, “processable dough” are used interchangeably herein. The processing of the dough typically involves passing of the dough through a pair of sheeting rolls to form a dough sheet. Preferably, the first phase of sheeting is performed on two parts of rested prepared (i.e. mixed) dough. The two sheets thus formed are typically combined (compounded) and passed through a second set of rolling sheets to form a single combined sheet. Said combined dough is typically processed via multiple pairs of sheeting rolls with decreasing roll gaps. The invention therefore provides a method for preparing sheetable dough comprising adding an amount of water and an effective amount of oxidase to flour and wherein said amount of water in the absence of said oxidase results in a dough that can not be processed due to its stickiness, wherein said dough is processed via at least two, even more preferably three and more preferably more then 3 times (i.e. at least 3 times) through sheeting rolls. In a most preferred embodiment the used sheeting rolls have decreasing roll gaps. The width of the final sheeting roll and subsequently the thickness of the final sheet depends on the product that is being produced and can be easily selected by a skilled person.

The terms “sheetable dough”, “machine processable dough”, “processable dough” typically refer to a dough which does not stick to sheeting rolls. Moreover, the terms refer to dough which has just been prepared by mixing compounds such as water, flour and an oxidase as well as to dough that has been rested, or to dough that has been processed by one or multiple sheeting rolls.

The term “dough” as used herein typically refers to a non-yeast comprising dough (i.e. a non-fermented dough) prepared from wheat flour and water and optional ingredients such as salt, that is subjected to a sheeting or rolling process. More specific, the term “dough” as used herein typically refers to dough suitable for preparing noodles, wrappings and/or dumplings, i.e., preferably said dough is sheetable noodle dough, sheetable wrapping dough or sheetable dumpling dough.

In an even more preferred embodiment, the term dough as used herein does not include pasta dough. In a preferred embodiment, the invention provides a method for preparing sheetable dough comprising adding an amount of water and an effective amount of oxidase to flour and wherein said amount of water in the absence of said oxidase results in a dough that can not be processed due to its stickiness, wherein said dough is not (Italian) pasta dough. A non-limiting example of pasta is spaghetti or tagliatella.

Although part or all of the steps involved in preparing sheetable dough can be done by hand (manually), in a preferred embodiment a method according to the invention is performed by a machine, i.e. in a preferred embodiment, the method according to the invention is a method for preparing machine-made sheetable dough.

The flour as used in a method according to the invention is typically hard or soft wheat flour and not the semolina flour which is typically used for the preparation of (Italian) pasta. In an even more preferred embodiment the flour used in a method according to the invention is of good quality, meaning that addition of separate wheat gluten (for improving the quality of the flour) is not necessary. The skilled person is very well capable of determining which flours are of good quality and which are not. Therefore, the invention preferably provides a method for preparing sheetable dough comprising adding an amount of water and an effective amount of oxidase to flour and wherein said amount of water in the absence of said oxidase results in a dough that can not be processed due to its stickiness, wherein said flour is of a quality that does not need fortification by wheat gluten.

In a preferred embodiment, the flour is non-durum wheat flour.

The used water is considered not critical. Tap or drinking water is a suitable source of water for use in a method according to the invention.

The order in which the water, flour and oxidase are added together is not critical. For example, the oxidase can be added to or dissolved in (part of) the water and the resulting combination can subsequently be added to the flour, optionally in combination with the remaining amount of water. As another example, the flour is added to the water (or the other way around) and the oxidase is added to the mixture of water and flour. The ingredients are usually mixed with help of a horizontal or vertical mixer.

Flour is typically produced in a large batch and smaller parts of one batch are used for separate dough preparation. Upon good storage conditions of the flour the maximal water addition level of said flour needs to be determined only once for the large batch and the obtained maximal water addition level result can be used as input for separate dough preparations from the large batch. Different dough preparations can be performed on one and the same day or within certain amount of time, for example within two weeks, 2 months or half a year. However, if the storage of the flour has not been optimal or when the dough producer wants to check the maximal water addition level (again) a method according to the invention can be supplemented with an additional step for determining the maximal water addition level. Hence, in a preferred embodiment the invention provides a method for preparing sheetable dough comprising adding an amount of water and an effective amount of oxidase to flour and wherein said amount of water in the absence of said oxidase results in a dough that can not be processed due to its stickiness, said method further comprising determining or predetermining (i.e. before the different components are added to each other and mixed) the maximal water addition level based on the starting flour and wherein said added amount of water is above the determined maximal water addition level.

The term water absorption level, water addition level and water content are used interchangeably herein. The terms water absorption level and water addition level are typically expressed as “baker percentages” and the term water content is typically expressed in real percentages (in relation to the amount of flour). Baker percentage, sometimes called formula percentage, is a way of indicating the proportion of ingredients which is typically used in making bread. Contrary to the usual way of expressing percentages, instead of the overall total adding up to 100%, ingredients are given as percent weight of the flour, which is 100%. All the ingredients are measured by their weight compared to the flour's. Thus, the flour always accounts for 100% and all the other ingredients make the total higher than 100%. For example, if a recipe calls for 10 pounds of flour and 5 pounds of water, the corresponding percentages will be 100% and 50%.

The phrase “wherein said amount of water in the absence of said oxidase results in a dough that can not be processed due to its stickiness”, refers to the fact that if the same amount of water is used without the addition of an oxidase, the dough can not be processed properly, because it sticks to the machine and in particular to the sheeting rolls. This is exemplified, for example, in example 4 and Table 1. If dough is prepared with normal water content (in example 4, 32-34%) without an oxidase the processability of the dough is good. Upon increasing the water content (in example 4 to 36-38%), the dough without an oxidase is too sticky for automated processing. Upon addition of an effective amount of an oxidase the dough has good machineability properties. When the water content in the dough is even further increased (in example 4, to 40%), the dough without an oxidase can not be processed any more because it sticks to the machine. However, upon addition of an effective amount of an oxidase, the resulting dough has an acceptable machineability. From these results it is clear that an increase in the water content above normal water content, the dough will have poor or even unacceptable processability properties. The poor processability can be circumvented by using an effective amount of an oxidase. It is the combined action of an effective amount of an oxidase and an increased water addition level (i.e. a level above the maximal water addition level) which is important for a method according to the invention.

In alternative wording the invention provides
a method for reducing (noodle) dough stickiness which stickiness is an effect of (due to) an increased water addition level in said dough comprising adding to the flour of said dough an effective amount of an oxidase; or
a method for preparing (noodle) dough comprising adding an amount of water and an oxidase to flour and wherein the presence of said oxidase leads to an increased water uptake capability essentially without effecting the processability of said dough and wherein the water level absorption level is above a (pre)determined maximal level based on the starting material; or
a method for increasing the maximal water addition level in (noodle) dough essentially without effecting the processability of said dough, comprising adding an amount of water and an oxidase to flour and wherein said amount of water in the absence of said oxidase results in a dough that can not be processed due to its stickiness.

The relative stickiness of dough can easily be determined by a skilled person. Without being limited to it, three measurement methods are described in more detail. The first method determines the amount of energy needed to separate a metal probe from a dough surface. This can for example be determined by using a TA-TX2 texture analyzer and subsequently determining the area under the curve or the peak value. The second method uses multiple different probes (for example made from different materials and/or having different shapes) and establishing which probe can be freed from dough without any dough sticking thereon. With help of the different probes one can establish a calibration set (for example if probes 1, 2 and 3 are free from dough, the dough is suitable for using in a sheeting or rolling process). A third method determines the amount of dough loss in a certain processing step and establishing which kind of losses result in acceptable sheeting or rolling efficiency.

Independent of the method used, the dough is preferably first processed into a sheet (i.e. a flat dough surface), otherwise reproducible measurements are not possible. Hence, there is a difference between dough which can be characterized according to any of the mentioned methods and which dough is thus possibly suitable for machine sheeting and dough which can not be used at all, i.e. even characterizing is not possible.

Any of the described measurement methods can be used to define dough stickiness. The terms “stickiness” or “relative stickiness” typically refer to stickiness during sheeting of dough. The inventors have determined that upon increasing the water addition level from 32 to 38% the stickiness increases, in the absence of an oxidase, from 37 to 74. In the presence of an oxidase, the stickiness is 23 in case of 32% water and 46 in case of 38% water. A stickiness of 46 equals the stickiness found for a dough with a water addition of 34% (in the absence of an oxidase), i.e. with the help of a method of the invention (in the presence of an oxidase) at least 4% additional water can be added without effecting the stickiness of the prepared dough.

In any of the above described methods, the used oxidase can be one type of an oxidase or a combination of different types of oxidases. In a preferred embodiment, the invention provides a method for preparing sheetable dough comprising adding an amount of water and an effective amount of oxidase to flour and wherein said amount of water in the absence of said oxidase results in a dough that can not be processed due to its stickiness (or any of the alternative wordings above), wherein only one type of enzyme is used and wherein said one type of enzyme is an oxidase.

As outlined above, a method according to the invention can comprise a step of determining the maximal water addition level. After determination of this level, a method according to the invention typically adds 1 to 10% additional water (i.e. added on top of the maximal water addition level) in combination with an effective amount of an oxidase. The additional amounts of water can be 1, 2, 3, 4, 5, 6, 7, 8, 9 or 10% or any value in between. Preferably 2-9% of additional water is added, such as 2, 3, 4, 5, 6, 7, 8 or 9% or any value in between. In yet a more preferred embodiment, a method according to the invention involves the addition of 3-8% additional water, such 3, 4, 5, 6, 7, or 8% or any value in between. In a preferred embodiment, the invention provides a method for preparing sheetable dough comprising adding an amount of water and an effective amount of oxidase to flour and wherein said amount of water in the absence of said oxidase results in a dough that can not be processed due to its stickiness, wherein said amount of water is 1 to 10% above the maximal water addition level. As outlined above the maximal water addition level depends on the starting material. When the maximal water addition level is for example 33% (based on the starting material), the amount of water added according to a method of the invention is 34-43%.

The mentioned percentages of water can refer to weight % or volume %. Typically a manufacturer will use weight % because of robustness and ease.

Oxidase enzymes suitable for use in a method according to the invention must meet two demands: they must be active under the conditions prevalent in the (for example noodle) dough, and they must find a suitable substrate in the dough matrix. In this respect, there is a difference between white and yellow noodles: whereas the pH in white noodle dough is neutral to slightly acidic (being the native pH of cereal doughs), alkaline noodles have much higher pH levels, due to the use of alkaline salts. The suitability of oxidase enzymes for use in these processes is therefore partly dependent on their pH-activity-profile. The skilled person is very well capable of determining a pH dependency curve and selecting the most optimal oxidase under a certain set of conditions.

In a preferred embodiment, the invention provides a method for preparing sheetable dough comprising adding an amount of water and an effective amount of oxidase to flour and wherein said amount of water in the absence of said oxidase results in a dough that can not be processed due to its stickiness, wherein said oxidase is an enzyme capable of oxidising sugar, in particular glucose (such as a glucose oxidase). Glucose oxidases are readily available for the skilled person.

Another suitable oxidase is a protein which has at least 45% amino acid identity with an isoamylalcoholoxidase. This oxidase will be discussed in more detail later on.

Without being limited to it, a description of 3 particular oxidases is provided herein:
(1) an oxidase from Aspergillus (referred to as AspGOX)
(2) a glucose oxidase from Penicillium (referred to as PenGOX or ZGL)
(3) an oxidase from Aspergillus which oxidase has at least 45% amino acid identity with an isoamylalcoholoxidase (referred to as ZLR or oxi 01)

An Oxidase from Aspergillus (AspGOX)

Glucose oxidases in general and glucose oxidases from Aspergillus are commercially available, for instance by DSM Food Specialties (Bakezyme GO) and by Novozymes (Gluzyme).

An Oxidase from Penicillium (PenGOX)

One example of a suitable oxidase from Penicillium is an isolated polypeptide which has glucose oxidase activity, and

(a) which has an amino acid sequence which has at least 80% amino acid sequence identity with SEQ ID NO: 3; or
(b) which is encoded by a polynucleotide sequence according to SEQ ID NO.1 or 2, or
(c) which is encoded by a polynucleotide which hybridizes with the nucleic acid sequence of SEQ ID NO: 1 or 2 and which is at least 80% or 90% identical over at least 60 nucleotides, or
(d) which is encoded by a polynucleotide which hybridizes with a nucleic acid sequence complementary to the nucleic acid sequence of SEQ ID NO: 1 or 2.

One advantage of the Penicillium glucose oxidase polypeptide is that the overexpression of this glucose oxidase polypeptide in Aspergillus niger gives a very good productivity in industrial media. In general, the expression of heterologous enzymes is much lower than the expression of homologous enzymes. Surprisingly, we find here that the productivity of the heterologous enzyme is much higher than that of the homologous Aspergillus enzyme. Furthermore this enzyme is active and can replace the Aspergillus niger enzyme in all its applications. This implies that most of the problems with the production of the Aspergillus niger glucose oxidase are due to the peculiarities of the Aspergillus enzyme, and not due to the host organism or culture conditions as discussed above.

As defined herein, glucose oxidase activity refers to EC 1.1.3.4, to the oxidation of glucose to gluconic acid with formation of hydrogen peroxide. Glucose oxidase can be assayed by determining the hydrogen peroxide generated by the enzyme. This may be measured by any suitable means known in the art, such as by a flurorescent probe or a colorometric. In one embodiment, glucose oxidase activity is measured in a relative way with a COBAS MIRA analyser. Under the influence of peroxidase, the hydrogen peroxide formed is reduced to water while oxidizing 2,2′ azino-bis-3-ethylbenzthiazoline-6-sulfonic acid (ABTS) forming a green coloured complex that can be measured spectrophotometrically at 405 nm. The results are related to a glucose oxidase preparation with an officially assigned activity. The activity is expressed in SRU (Sarrett Units). One SRU unit is defined as the amount of enzyme that gives an oxygen uptake of 10 m³/minute in a Warburg manometer, at 30° C. and in the presence of an excess of oxygen, catalase and a 3.3% glucose solution in a phosphate buffer of pH 5.4.

The Penicillium glucose oxidase may have other substrates, in particular other sugars, such as lactose or galactose. In a preferred embodiment, the glucose oxidase of Penicillium has a preference for glucose as a substrate over other substrates. In a more preferred embodiment, the glucose oxidase of Penicillium has glucose oxidase activity as its main activity.

As defined herein, an oxidase used in a method according to the invention is an endogenously produced or a recombinant polypeptide which is essentially free from other non-glucose oxidase polypeptides, and is typically at least about 20% pure, preferably at least about 40% pure, more preferably at least about 60% pure, even more preferably at least about 80% pure, still more preferably about 90% pure, and most preferably about 95% pure, as determined by SDS-PAGE. The oxidase may be isolated by centrifugation and chromatographic methods, or any other technique known in the art for obtaining pure proteins from crude solutions. It will be understood that the oxidase may be mixed with carriers or diluents which do not interfere with the intended purpose of the oxidase, and thus the oxidase in this form will still be regarded as isolated. It will generally comprise the oxidase in a preparation in which more than 20%, for example more than 30%, 40%, 50%, 80%, 90%, 95% or 99%, by weight of the proteins in the preparation is PenGOX.

Preferably, the oxidase is obtainable from a microorganism which possesses a gene encoding an enzyme with glucose oxidase activity. More preferably said polypeptide is secreted from a microorganism. Even more preferably the microorganism is fungal, and optimally is a filamentous fungus. Preferred microorganisms are of the genus Penicillium, such as those of the species Penicillium chrysogenum.

Preferably the isolated Penicillium oxidase has an amino acid sequence which has at least 80%, preferably at least 85%, more preferably at least 90%, even more preferably at least 95%, still more preferably at least 98%, and most preferably at least 99% sequence identity to SEQ ID NO:3 and which has glucose oxidase activity.

For the purposes of the present invention, the degree of identity between two or more amino acid sequences is determined by BLAST P protein database search program (Altschul et al., 1997, Nucleic Acids Research 25: 3389-3402) with matrix Blosum 62, an expected threshold of 10, word size 3, gap existence costs of 11 and gap extension costs of 1.

Said oxidase may comprise the amino acid sequence set forth in SEQ ID NO:3 or a substantially homologous sequence, or a fragment of either sequence having glucose oxidase activity. In general, the naturally occurring amino acid sequence shown in SEQ ID NO: 3 is preferred.

The Penicillium oxidase may also comprise a naturally occurring variant or species homologue of the polypeptide of SEQ ID NO: 3.

A variant is an oxidase that occurs naturally in, for example, fungal, bacterial, yeast or plant cells, the variant having glucose oxidase activity and a sequence substantially similar to the protein of SEQ ID NO: 3. The term “variants” refers to oxidases which have the same essential character or basic biological functionality as the glucose oxidase of SEQ ID NO: 3, and includes allelic variants. Preferably, a variant oxidase has at least the same level of glucose oxidase activity as the oxidase of SEQ ID NO: 3. Variants include allelic variants either from the same strain as the oxidase of SEQ ID NO: 3 or from a different strain of the same genus or species.

Similarly, a species homologue of the Penicillium oxidase is an equivalent protein of similar sequence which is a glucose oxidase and occurs naturally in another species.

Variants and species homologues can be isolated using the procedures described herein and performing such procedures on a suitable cell source, for example a bacterial, yeast, fungal or plant cell. Also possible is to use a probe to probe DNA libraries made from yeast, bacterial, fungal or plant cells in order to obtain clones expressing variants or species homologues of the oxidase of SEQ ID NO:3. The methods that can be used to isolate variants and species homologues of a known gene are extensively described in literature, and known to those skilled in the art. These genes can be manipulated by conventional techniques to generate a polypeptide of the invention which thereafter may be produced by recombinant or synthetic techniques known per se.

The sequence of the oxidase of SEQ ID NO: 3 and of variants and species homologues can also be modified to provide oxidases of the invention. Amino acid substitutions may be made, for example from 1, 2 or 3 to 10, 20 or 30 substitutions. The same number of deletions and insertions may also be made. These changes may be made outside regions critical to the function of the oxidase, as such a modified oxidase will retain its glucose oxidase activity.

Said oxidases include fragments of the above mentioned full length oxidases and of variants thereof, including fragments of the sequence set out in SEQ ID NO: 3. Such fragments will typically retain activity as an glucose oxidase. Fragments may be at least 50, 100 or 200 amino acids long or may be this number of amino acids short of the full length sequence shown in SEQ ID NO: 3.

The oxidases can, if necessary, be produced by synthetic means although usually they will be made recombinantly as described below. Synthetic and recombinant polypeptides may be modified, for example, by the addition of histidine residues or a T7 tag to assist their identification or purification, or by the addition of a signal sequence to promote their secretion from a cell.

Thus, the variant sequences may comprise those derived from strains of Penicillium other than the strain from which the oxidase of SEQ ID NO:3 was isolated. Variants can be identified from other Penicillium strains by looking for glucose oxidase activity and cloning and sequencing as described herein. Variants may include the deletion, modification or addition of single amino acids or groups of amino acids within the protein sequence, as long as the peptide maintains the basic biological functionality of the glucose oxidase of SEQ ID NO: 3

Amino acid substitutions may be made, for example from 1, 2 or from 3 to 10, 20 or 30 substitutions. The modified polypeptide will generally retain activity as a glucose oxidase. Conservative amino acid substitutions may be made; such substitutions are well known in the art.

Shorter or longer polypeptide sequences are within the scope of the invention, i.e. such polypeptides can be used in a method according to the invention. For example, a peptide of at least 50 amino acids or up 100, 150, 200, 300, 400, 500, 600, 700 or 800 amino acids in length is considered to fall within the scope of the invention as long as it demonstrates the basic biological functionality of the glucose oxidase of SEQ ID NO:3. In particular, but not exclusively, this aspect of the invention encompasses the situation in which the protein is a fragment of the complete protein sequence.

For the present invention it is especially useful that the protein of interest is actively secreted into the growth medium. Secreted proteins are normally originally synthesized as pre-proteins and the pre-sequence (signal sequence) is subsequently removed during the secretion process. The secretion process is basically similar in prokaryotes and eukaryotes: the actively secreted pre-protein is threaded through a membrane, the signal sequence is removed by a specific signal peptidase, and the mature protein is (re)-folded. Also for the signal sequence a general structure can be recognized. Signal sequences for secretion are located at the amino-terminus of the pre-protein, and are generally 15-35 amino-acids in length. The amino-terminus preferably contains positively charged amino-acids, and preferably no acidic amino-acids. It is thought that this positively charged region interacts with the negatively charged head groups of the phospholipids of the membrane. This region is followed by a hydrophobic, membrane-spanning core region. This region is generally 10-20 amino-acids in length and consists mainly of hydrophobic amino-acids. Charged amino-acids are normally not present in this region. The membrane spanning region is followed by the recognition site for signal peptidase. The recognition site consists of amino-acids with the preference for small-X-small. Small amino-acids can be alanine, glycine, serine or cysteine. X can be any amino acids.

In another embodiment, the isolated oxidase (PenGOX) is encoded by a polynucleotide sequence according to SEQ ID NO.1 or 2.

In yet a further embodiment, the isolated oxidase is encoded by a polynucleotide sequence which hybridizes or is capable of hybrizing with the nucleic acid sequence of SEQ ID NO:1 or 2 and which is at least 80% or at least 90% identical over at least 60 nucleotides.

Preferably, the isolated oxidase is encoded by a polynucleotide sequence which hybridizes or is capable of hybrizing with the nucleic acid sequence of SEQ ID NO.1 or 2 and which is at least 80% or at least 90% identical over at least 100 nucleotides. More preferably, the isolated oxidase is encoded by a polynucleotide sequence which hybridizes or is capable of hybrizing with the nucleic acid sequence of SEQ ID NO:1 or 2 and which is at least 80% or at least 90% identical over at least 200 nucleotides.

In another embodiment, the isolated oxidase is encoded by a polynucleotide sequence which hybridizes with a nucleic acid strand complementary to SEQ ID NO:1 or 2.

In the context of the present invention, hybridization is under low stringency conditions, more preferably under medium stringency conditions, and most preferably under high stringency conditions.

The term “capable of hybridizing” means that the target polynucleotide of the invention can hybridize to the nucleic acid used as a probe (for example, the nucleotide sequence set forth in SEQ ID NO: 1, or a fragment thereof or the complement of SEQ ID NO: 1, or a fragment thereof) at a level significantly above background.

All the above-mentioned polynucleotides which encode oxidases are encompassed in the present invention. Therefore, in a further aspect, the present invention describes polynucleotides encoding oxidases as described herein. The polynucleotide sequence may be RNA or DNA, including genomic DNA, synthetic DNA or cDNA. Preferably, the nucleotide sequence is DNA and most preferably, a genomic DNA sequence. Polynucleotides may include within them synthetic or modified nucleotides including peptide nucleic acids. Typically, a polynucleotide comprises a contiguous sequence of nucleotides which is capable of hybridizing under selective conditions to the coding sequence or the complement of the coding sequence of SEQ ID NO: 1 or to SEQ ID NO. 2. Such nucleotides can be synthesized according to methods well known in the art. An isolated polynucleotide which hybridizes or is capable of hybridizing with SEQ ID No. 1 or 2 is also part of the invention.

A polynucleotide can hybridize to the coding sequence or the complement of the coding sequence of SEQ ID NO: 2 at a level significantly above background. Background hybridization may occur, for example, because of other cDNAs present in a cDNA library. The signal level generated by the interaction between a polynucleotide as described and the coding sequence or complement of the coding sequence of SEQ ID NO: 2 is typically at least 10 fold, preferably at least 20 fold, more preferably at least 50 fold, and even more preferably at least 100 fold, as intense as interactions between other polynucleotides and the coding sequence of SEQ ID NO: 2. The techniques used to perform hybridization are well described in general laboratory manuals (Sambrook et al. (1989) Molecular cloning: a laboratory manual. Cold Spring Harbor Laboratory Press) and therefore known in the art. The intensity of interaction may be measured, for example, by radio-labeling the probe, for example with ³²P. Selective hybridization may typically be achieved using conditions of low stringency (0.3 M sodium chloride and 0.03 M sodium citrate at about 40° C.), medium stringency (for example, 0.3 M sodium chloride and 0.03 M sodium citrate at about 50° C.) or high stringency (for example, 0.3 M sodium chloride and 0.03 M sodium citrate at about 60° C.).

A polynucleotide also includes synthetic genes that can encode for the oxidase of SEQ ID NO: 3 or variants thereof. It is sometimes preferable to adapt the codon usage of a gene to the preferred bias in a production host. Techniques to design and construct synthetic genes are generally available (i.e. http://www.dnatwopointo.com/).

An Oxidase from Aspergillus (ZLR or oxi 01)

WO2007/090675 describes novel oxidoreductases isolated from Aspergillus niger. For the present invention, the protein with SEQ ID NO: 013, the gene comprising SEQ ID No: 001 as well as its complete cDNA sequence (SEQ ID NO: 007) is extremely useful as an oxidase in a method according to the invention. The encoded protein has 47% amino acid identity with the mreA protein (which has been annotated as a isoamylalcohol dehydrogenase) of Aspergillus oryzae.

Any of the mentioned oxidases can be obtained via a natural oxidase producing micro-organism or recombinantly via any suitable production organism. The following paragraphs provide general information in respect of an oxidase that can be used in a method according to the invention, such as the type of modifications, production means etc. Explicit reference is made to SEQ ID NO: 2 of the Penicillium oxidase. However, these paragraphs are equally well applicable to the sequences of other oxidases, such as, but not limited to, AspGOX or ZLR.

The term “oxidase” used herein can also refer to any functional equivalent or functional fragment thereof. A functional fragment is a part of the complete oxidase which is still has at least part of the original activity. A functional equivalent is for example a oxidase mutant which comprises one or multiple mutations in its amino acid sequence which mutations do not or do hardly not effect the activity.

Modifications

A number of different types of modifications to polynucleotides are known in the art. These include a methylphosphonate and phosphorothioate backbones, and addition of acridine or polylysine chains at the 3′ and/or 5′ ends of the molecule. For the purposes of the present invention, it is to be understood that the polynucleotides described herein may be modified by any method available in the art.

It is to be understood that skilled persons may, using routine techniques, make nucleotide substitutions that do not affect the polypeptide sequence encoded by the polynucleotides described herein to reflect the codon usage of any particular host organism in which the oxidases are to be expressed.

For example, the coding sequence of SEQ ID NO: 2 may be modified by nucleotide substitutions, for example from 1, 2 or 3 to 10, 25, 50, 100, or more substitutions. The polynucleotide of SEQ ID NO: 2 may alternatively or additionally be modified by one or more insertions and/or deletions and/or by an extension at either or both ends. The modified polynucleotide generally encodes a polypeptide which has glucose oxidase activity. Degenerate substitutions may be made and/or substitutions may be made which would result in a conservative amino acid substitution when the modified sequence is translated, for example as discussed with reference to polypeptides later.

Homologues

A nucleotide sequence which is capable of selectively hybridizing to the complement of the DNA coding sequence of, for example, SEQ ID NO:2 is included for use in a method according to the invention and will generally have at least 50% or 60%, at least 70%, at least 80%, at least 90%, at least 95%, at least 98% or at least 99% sequence identity to the coding sequence of SEQ ID NO:2 over a region of at least 60, preferably at least 100, more preferably at least 200 contiguous nucleotides or most preferably over the full length of SEQ ID NO:2. Likewise, a nucleotide which encodes an active glucose oxidase and which is capable of selectively hybridizing to a fragment of a complement of the DNA coding sequence of SEQ ID NO: 2, is also embraced by the invention. Any combination of the above mentioned degrees of identity and minimum sizes may be used to define polynucleotides, with the more stringent combinations (i.e. higher identity over longer lengths) being preferred. Thus, for example, a polynucleotide which is at least 80% or 90% identical over 60, preferably over 100 nucleotides, forms one aspect of the invention, as does a polynucleotide which is at least 90% identical over 200 nucleotides.

The BLASTP and BLAST N algorithms can be used to calculate sequence identity or to line up sequences (such as identifying equivalent or corresponding sequences, for example on their default settings).

Software for performing BLAST analyses is publicly available through the National Center for Biotechnology Information (http://www.ncbi.nlm.nih.gov/). This algorithm involves first identifying high scoring sequence pair (HSPs) by identifying short words of length W in the query sequence that either match or satisfy some positive-valued threshold score T when aligned with a word of the same length in a database sequence. T is referred to as the neighborhood word score threshold. These initial neighborhood word hits act as seeds for initiating searches to find HSPs containing them. The word hits are extended in both directions along each sequence for as far as the cumulative alignment score can be increased. Extensions for the word hits in each direction are halted when: the cumulative alignment score falls off by the quantity X from its maximum achieved value; the cumulative score goes to zero or below, due to the accumulation of one or more negative-scoring residue alignments; or the end of either sequence is reached. The BLAST algorithm parameters W, T and X determine the sensitivity and speed of the alignment. The BLASTN program from DNA-DNA comparison uses as defaults a word length (W) of 11, expectation (E) of 10, and a comparison of both strands. The BLASTP program for protein-protein comparison uses as defaults a word length (W) of 3, the BLOSUM62 scoring matrix, a gap existence penalty of 11 with a gap extension penalty of 1, and an expectation (E) of 10.

The BLAST algorithm performs a statistical analysis of the similarity between two sequences. One measure of similarity provided by the BLAST algorithm is the smallest sum probability (P(N)), which provides an indication of the probability by which a match between two nucleotide or amino acid sequences would occur by chance. For example, a sequence is considered similar to another sequence if the smallest sum probability in comparison of the first sequence to the second sequence is less than about 1, preferably less than about 0.1, more preferably less than about 0.01, and most preferably less than about 0.001.

Primers and Probes

Polynucleotides as described or mentioned herein include and may be used as primers, for example as polymerase chain reaction (PCR) primers, as primers for alternative amplification reactions, or as probes for example labeled with a revealing label by conventional means using radioactive or non-radioactive labels, or the polynucleotides may be cloned into vectors. Such primers, probes and other fragments will be at least 15, for example at least 20, 25, 30 or 40 nucleotides in length. They will typically be up to 40, 50, 60, 70, 100, 150, 200 or 300 nucleotides in length, or even up to a few nucleotides (such as 5 or 10 nucleotides) short of the coding sequence of SEQ ID NO: 2.

In general, primers will be produced by synthetic means, involving a step-wise manufacture of the desired nucleic acid sequence one nucleotide at a time. Techniques for accomplishing this and protocols are readily available in the art. Longer polynucleotides will generally be produced using recombinant means, for example using PCR cloning techniques. This will involve making a pair of primers (typically of about 15-30 nucleotides) to amplify the desired region of the glucose oxidase to be cloned, bringing the primers into contact with mRNA, cDNA or genomic DNA obtained from a yeast, bacterial, plant, prokaryotic or fungal cell, for example of an Penicillium strain, performing a polymerase chain reaction under conditions suitable for the amplification of the desired region, isolating the amplified fragment (e.g. by purifying the reaction mixture on an agarose gel) and recovering the amplified DNA. The primers may be designed to contain suitable restriction enzyme recognition sites so that the amplified DNA can be cloned into a suitable cloning vector.

Alternatively, synthetic genes can be constructed that encompass the coding region of the secreted glucose oxidase or variants thereof. Polynucleotides that are altered in many positions, but still encode the same protein can be conveniently designed and constructed using these techniques. This has as advantage that the codon usage can be adapted to the preferred expression host, so productivity of the protein in this host can be improved. Also the polynucleotide sequence of a gene can be changed to improve mRNA stability or reduced turnover. This can lead to improved expression of the desired protein or variants thereof. Additionally, the polynucleotide sequence can be changed in a synthetic gene such that mutations are made in the protein sequence that have a positive effect on secretion efficiency, stability, proteolytic vulnerability, temperature optimum, specific activity or other relevant properties for industrial production or application of the protein. Companies that provide services to construct synthetic genes and optimize codon usage are generally available.

Such techniques may be used to obtain all or part of the polynucleotides encoding the glucose oxidase sequences described herein. Introns, promoter and trailer regions are within the scope of the invention and may also be obtained in an analogous manner (e.g. by recombinant means, PCR or cloning techniques), starting with genomic DNA from a fungal, yeast, bacterial plant or prokaryotic cell.

The polynucleotides or primers may carry a revealing label. Suitable labels include radioisotopes such as 32P or 35S, fluorescent labels, enzyme labels, or other protein labels such as biotin. Such labels may be added to polynucleotides or primers of the invention and may be detected using techniques known to persons skilled in the art.

Polynucleotides or primers (or fragments thereof) labeled or unlabelled may be used in nucleic acid-based tests for detecting or sequencing a glucose oxidase or a variant thereof in a fungal sample. Such detection tests will generally comprise bringing a fungal sample suspected of containing the DNA of interest into contact with a probe comprising a polynucleotide or primer of the invention under hybridizing conditions, and detecting any duplex formed between the probe and nucleic acid in the sample. Detection may be achieved using techniques such as PCR or by immobilizing the probe on a solid support, removing any nucleic acid in the sample which is not hybridized to the probe, and then detecting any nucleic acid which is hybridized to the probe. Alternatively, the sample nucleic acid may be immobilized on a solid support, the probe hybridized and the amount of probe bound to such a support after the removal of any unbound probe detected.

The probes as described herein may conveniently be packaged in the form of a test kit in a suitable container. In such kits the probe may be bound to a solid support where the assay format for which the kit is designed requires such binding. The kit may also contain suitable reagents for treating the sample to be probed, hybridizing the probe to nucleic acid in the sample, control reagents, instructions, and the like. The probes and polynucleotides as described herein may also be used in micro-assay.

Preferably, the polynucleotide is obtainable from the same organism as the polypeptide, such as a fungus, in particular a fungus of the genus Penicillium.

Production of Polynucleotides

Polynucleotides which do not have 100% identity with SEQ ID NO:1 or 2 but fall within the scope of the invention can be obtained in a number of ways. Thus, variants of the glucose oxidase sequence described herein may be obtained for example, by probing genomic DNA libraries made from a range of organisms, such as those discussed as sources of the oxidases. In addition, other fungal, plant or prokaryotic homologues of glucose oxidase may be obtained and such homologues and fragments thereof in general will be capable of hybridizing to SEQ ID NO: 1 or 2. Such sequences may be obtained by probing cDNA libraries or genomic DNA libraries from other species, and probing such libraries with probes comprising all or part of SEQ ID NO: 1 or 2 under conditions of low, medium to high stringency (as described earlier). Nucleic acid probes comprising all or part of SEQ ID NO: 1 or 2 may be used to probe cDNA or genomic libraries from other species, such as those described as sources for the herein described oxidases.

Species homologues may also be obtained using degenerate PCR, which uses primers designed to target sequences within the variants and homologues which encode conserved amino acid sequences. The primers can contain one or more degenerate positions and will be used at stringency conditions lower than those used for cloning sequences with single sequence primers against known sequences.

Alternatively, such polynucleotides may be obtained by site directed mutagenesis of the (for example glucose) oxidase sequences or variants thereof. This may be useful where, for example, silent codon changes to sequences are required to optimize codon preferences for a particular host cell in which the polynucleotide sequences are being expressed. Other sequence changes may be made in order to introduce restriction enzyme recognition sites, or to alter the property or function of the polypeptides encoded by the polynucleotides.

The invention includes double stranded polynucleotides comprising a polynucleotide of the invention and its complement.

The present invention also describes polynucleotides encoding the polypeptides described above which do not hybridize to the sequence of SEQ ID NO: 1 or SEQ ID NO: 2, although this will generally be desirable. Otherwise, such polynucleotides may be labeled, used, and made as described above if desired.

Recombinant Polynucleotides

The invention also describes vectors comprising a herein mentioned polynucleotide, including cloning and expression vectors, and in another aspect methods of growing, transforming or transfecting such vectors into a suitable host cell, for example under conditions in which expression of a polypeptide of, or encoded by a sequence of, the invention occurs. Provided also are host cells comprising a polynucleotide or vector wherein the polynucleotide is heterologous to the genome of the host cell. The term “heterologous”, usually with respect to the host cell, means that the polynucleotide does not naturally occur in the genome of the host cell or that the polypeptide is not naturally produced by that cell. Preferably, the host cell is a yeast cell, for example a yeast cell of the genus Kluyveromyces, Pichia, Hansenula, Candida or Saccharomyces or a filamentous fungal cell, for example of the genus Aspergillus, Trichoderma, Chrysosporium or Fusarium.

The polynucleotides as described herein may be part of a nucleic acid construct, where it is operably linked to one or more control sequences that direct the production of the polypeptide in a suitable expression host. Typically such constructs are used in recombinant expression vectors.

Vectors

The vector into which an expression cassette is inserted may be any vector that may conveniently be subjected to recombinant DNA procedures, and the choice of the vector will often depend on the host cell into which it is to be introduced. Thus, the vector may be an autonomously replicating vector, i.e. a vector which exists as an extra-chromosomal entity, the replication of which is independent of chromosomal replication, such as a plasmid. Alternatively, the vector may be one which, when introduced into a host cell, is integrated into the host cell genome and replicates together with the chromosome(s) into which it has been integrated.

Preferably, when a polynucleotide is in a vector it is operably linked to a regulatory sequence which is capable of providing for the expression of the coding sequence by the host cell, i.e. the vector is an expression vector. The term “operably linked” refers to a juxtaposition wherein the components described are in a relationship permitting them to function in their intended manner. A regulatory sequence such as a promoter, enhancer or other expression regulation signal “operably linked” to a coding sequence is positioned in such a way that expression of the coding sequence is achieved under production conditions.

The vectors may, for example in the case of plasmid, cosmid, virus or phage vectors, be provided with an origin of replication, optionally a promoter for the expression of the polynucleotide and optionally an enhancer and/or a regulator of the promoter. A terminator sequence may be present, as may be a poly-adenylation sequence. The vectors may contain one or more selectable marker genes, for example an ampicillin resistance gene in the case of a bacterial plasmid or a neomycin resistance gene for a mammalian vector. Vectors may be used in vitro, for example for the production of RNA or can be used to transfect or transform a host cell.

The DNA sequence encoding the polypeptide is preferably introduced into a suitable host as part of an expression construct in which the DNA sequence is operably linked to expression signals which are capable of directing expression of the DNA sequence in the host cells. For transformation of the suitable host with the expression construct transformation procedures are available which are well known to the skilled person. The expression construct can be used for transformation of the host as part of a vector carrying a selectable marker, or the expression construct is co-transformed as a separate molecule together with the vector carrying a selectable marker. The vectors may contain one or more selectable marker genes.

Preferred selectable markers include but are not limited to those that complement a defect in the host cell or confer resistance to a drug. They include for example versatile marker genes that can be used for transformation of most filamentous fungi and yeasts such as acetamidase genes or cDNAs (the amdS, niaD, facA genes or cDNAs from A.nidulans, A.oryzae, or A.niger), or genes providing resistance to antibiotics like G418, hygromycin, bleomycin, kanamycin, phleomycin or benomyl resistance (benA). Alternatively, specific selection markers can be used such as auxotrophic markers which require corresponding mutant host strains: e.g. URA3 (from S.cerevisiae or analogous genes from other yeasts), pyrG or pyrA (from A.nidulans or A.niger), argB (from A.nidulans or A.niger) or trpC. In a preferred embodiment the selection marker is deleted from the transformed host cell after introduction of the expression construct so as to obtain transformed host cells capable of producing the polypeptide which are free of selection marker genes.

Other markers include ATP synthetase subunit 9 (oliC), orotidine-5′-phosphate-decarboxylase (pvrA), the bacterial G418 resistance gene (useful in yeast, but not in filamentous fungi), the ampicillin resistance gene (E. coli), the neomycin resistance gene (Bacillus) and the E. coli uidA gene, coding for glucuronidase (GUS). Vectors may be used in vitro, for example for the production of RNA or to transfect or transform a host cell.

For most filamentous fungi and yeasts, the expression construct is preferably integrated into the genome of the host cell in order to obtain stable transformants. However, for certain yeasts suitable episomal vector systems are also available into which the expression construct can be incorporated for stable and high level expression. Examples thereof include vectors derived from the 2 μm, CEN and pKD1 plasmids of Saccharomyces and Kluyveromyces, respectively, or vectors containing an AMA sequence (e.g. AMA1 from Aspergillus). When expression constructs are integrated into host cell genomes, the constructs are either integrated at random loci in the genome, or at predetermined target loci using homologous recombination, in which case the target loci preferably comprise a highly expressed gene. A highly expressed gene is a gene whose mRNA can make up at least 0.01% (w/w) of the total cellular mRNA, for example under induced conditions, or alternatively, a gene whose gene product can make up at least 0.2% (w/w) of the total cellular protein, or, in case of a secreted gene product, can be secreted to a level of at least 0.05 g/l.

An expression construct for a given host cell will usually contain the following elements operably linked to each other in consecutive order from the 5′-end to 3′-end relative to the coding strand of the sequence encoding the polypeptide of the first aspect: (1) a promoter sequence capable of directing transcription of the DNA sequence encoding the polypeptide in the given host cell, (2) preferably, a 5′-untranslated region (leader), (3) optionally, a signal sequence capable of directing secretion of the polypeptide from the given host cell into the culture medium, (4) the DNA sequence encoding a mature and preferably active form of the polypeptide, and preferably also (5) a transcription termination region (terminator) capable of terminating transcription downstream of the DNA sequence encoding the polypeptide.

Downstream of the DNA sequence encoding the polypeptide, the expression construct preferably contains a 3′ untranslated region containing one or more transcription termination sites, also referred to as a terminator. The origin of the terminator is less critical. The terminator can for example be native to the DNA sequence encoding the polypeptide. However, preferably a bacterial terminator is used in bacterial host cells, a yeast terminator is used in yeast host cells and a filamentous fungal terminator is used in filamentous fungal host cells. More preferably, the terminator is endogenous to the host cell in which the DNA sequence encoding the polypeptide is expressed.

Enhanced expression of the polynucleotide encoding the polypeptide of the invention may also be achieved by the selection of heterologous regulatory regions, e.g. promoter, signal sequence and terminator regions, which serve to increase expression and, if desired, secretion levels of the protein of interest from the chosen expression host and/or to provide for the inducible control of the expression of an oxidase.

Aside from the promoter native to the gene encoding an oxidase, other promoters may be used to direct expression of an oxidase. The promoter may be selected for its efficiency in directing the expression of an oxidsae in the desired expression host.

Promoters/enhancers and other expression regulation signals may be selected to be compatible with the host cell for which the expression vector is designed. For example prokaryotic promoters may be used, in particular those suitable for use in E.coli strains. When expression of an oxidase is carried out in mammalian cells, mammalian promoters may be used. Tissues-specific promoters, for example hepatocyte cell-specific promoters, may also be used. Viral promoters may also be used, for example the Moloney murine leukaemia virus long terminal repeat (MMLV LTR), the rous sarcoma virus (RSV) LTR promoter, the SV40 promoter, the human cytomegalovirus (CMV) IE promoter, herpes simplex virus promoters or adenovirus promoters.

Suitable yeast promoters include the S. cerevisiae GAL4 and ADH promoters and the S. pombe nmt1 and adh promoter. Mammalian promoters include the metallothionein promoter which can be induced in response to heavy metals such as cadmium. Viral promoters such as the SV40 large T antigen promoter or adenovirus promoters may also be used. All these promoters are readily available in the art.

Mammalian promoters, such as β-actin promoters, may be used. Tissue-specific promoters, in particular endothelial or neuronal cell specific promoters (for example the DDAHI and DDAHII promoters), are especially preferred. Viral promoters may also be used, for example the Moloney murine leukaemia virus long terminal repeat (MMLV LTR), the rous sarcoma virus (RSV) LTR promoter, the SV40 promoter, the human cytomegalovirus (CMV) IE promoter, adenovirus, HSV promoters (such as the HSV IE promoters), or HPV promoters, particularly the HPV upstream regulatory region (URR). Viral promoters are readily available in the art.

A variety of promoters can be used that are capable of directing transcription in the host cells as herein described. Preferably the promoter sequence is derived from a highly expressed gene as previously defined. Examples of preferred highly expressed genes from which promoters are preferably derived and/or which are comprised in preferred predetermined target loci for integration of expression constructs, include but are not limited to genes encoding glycolytic enzymes such as triose-phosphate isomerases (TPI), glyceraldehyde-phosphate dehydrogenases (GAPDH), phosphoglycerate kinases (PGK), pyruvate kinases (PYK), alcohol dehydrogenases (ADH), as well as genes encoding amylases, glucoamylases, proteases, xylanases, cellobiohydrolases, β-galactosidases, alcohol (methanol) oxidases, elongation factors and ribosomal proteins. Specific examples of suitable highly expressed genes include e.g. the LAC4 gene from Kluyveromyces sp., the methanol oxidase genes (AOX and MOX) from Hansenula and Pichia, respectively, the glucoamylase (glaA) genes from A.niger and A.awamori, the A.oryzae TAKA-amylase gene, the A.nidulans gpdA gene and the T.reesei cellobiohydrolase genes.

Examples of strong constitutive and/or inducible promoters which are preferred for use in fungal expression hosts are those which are obtainable from the fungal genes for xylanase (xlnA), phytase, ATP-synthetase subunit 9 (oliC), triose phosphate isomerase (tpi), alcohol dehydrogenase (AdhA), amylase (amy), amyloglucosidase (AG—from the glaA gene), acetamidase (amdS) and glyceraldehyde-3-phosphate dehydrogenase (gpd) promoters.

Examples of strong yeast promoters which may be used include those obtainable from the genes for alcohol dehydrogenase, glyceraldehyde-3-phosphate dehydrogenase, lactase, 3-phosphoglycerate kinase, plasma membrane ATPase (PMA1) and triosephosphate isomerase.

Examples of strong bacterial promoters which may be used include the amylase and SPo2 promoters as well as promoters from extracellular protease genes.

Promoters suitable for plant cells which may be used include napaline synthase (nos), octopine synthase (ocs), mannopine synthase (mas), ribulose small subunit (rubisco ssu), histone, rice actin, phaseolin, cauliflower mosaic virus (CMV) 35S and 19S and circovirus promoters.

The vector may further include sequences flanking the polynucleotide giving rise to RNA which comprise sequences homologous to ones from eukaryotic genomic sequences, preferably fungal genomic sequences, or yeast genomic sequences. This will allow the introduction of an oxidase into the genome of fungi or yeasts by homologous recombination. In particular, a plasmid vector comprising the expression cassette flanked by fungal sequences can be used to prepare a vector suitable for delivering an oxidase to a fungal cell. Transformation techniques using these fungal vectors are known to those skilled in the art.

Host Cells and Expression

In a further aspect the invention describes a process for preparing an oxidase for use in a method according to the invention which comprises cultivating a host cell transformed or transfected with an expression vector as described above under conditions suitable for expression by the vector of a coding sequence encoding the oxidase, and recovering the expressed polypeptide. Polynucleotides can be incorporated into a recombinant replicable vector, such as an expression vector. The vector may be used to replicate the nucleic acid in a compatible host cell. Thus in a further embodiment, the invention describes a method of making a polynucleotide of the invention by introducing a polynucleotide into a replicable vector, introducing the vector into a compatible host cell, and growing the host cell under conditions which bring about the replication of the vector. Suitable host cells include bacteria such as E. coli, yeast, mammalian cell lines and other eukaryotic cell lines, for example insect cells such as Sf9 cells and (e.g. filamentous) fungal cells.

Preferably an oxidase is produced as a secreted protein in which case the DNA sequence encoding a mature form of the oxidase in the expression construct may be operably linked to a DNA sequence encoding a signal sequence. In the case where the gene encoding the secreted protein has in the wild type strain a signal sequence preferably the signal sequence used will be native (homologous) to the DNA sequence encoding the oxidase. Alternatively the signal sequence is foreign (heterologous) to the DNA sequence encoding the oxidase, in which case the signal sequence is preferably endogenous to the host cell in which the DNA sequence is expressed. Examples of suitable signal sequences for yeast host cells are the signal sequences derived from yeast MFalpha genes. Similarly, a suitable signal sequence for filamentous fungal host cells is e.g. a signal sequence derived from a filamentous fungal amyloglucosidase (AG) gene, e.g. the A. niger glaA gene. This signal sequence may be used in combination with the amyloglucosidase (also called (gluco) amylase) promoter itself, as well as in combination with other promoters. Hybrid signal sequences may also be used within the context of the present invention.

Preferred heterologous secretion leader sequences are those originating from the fungal amyloglucosidase (AG) gene (glaA—both 18 and 24 amino acid versions e.g. from Aspergillus), the MFalpha gene (yeasts e.g. Saccharomyces and Kluyveromyces) or the alpha-amylase gene (Bacillus).

The vectors may be transformed or transfected into a suitable host cell as described above to provide for expression of an oxidase of the invention. This process may comprise culturing a host cell transformed with an expression vector as described above under conditions suitable for expression of an oxidase, and optionally recovering the expressed polypeptide.

A further aspect of the invention thus describes host cells transformed or transfected with or comprising a polynucleotide or vector as described herein. Preferably the polynucleotide is carried in a vector which allows the replication and expression of the polynucleotide. The cells will be chosen to be compatible with the said vector and may for example be prokaryotic (for example bacterial), or eukaryotic fungal, yeast or plant cells.

The invention encompasses processes for the production of an oxidase of the invention by means of recombinant expression of a DNA sequence encoding the polypeptide. For this purpose the DNA sequence as described herein can be used for gene amplification and/or exchange of expression signals, such as promoters, secretion signal sequences, in order to allow economic production of the polypeptide in a suitable homologous or heterologous host cell. A homologous host cell is herein defined as a host cell which is of the same species or which is a variant within the same species as the species from which the DNA sequence is derived.

Suitable host cells are preferably prokaryotic microorganisms such as bacteria, or more preferably eukaryotic organisms, for example fungi, such as yeasts or filamentous fungi, or plant cells. In general, yeast cells are preferred over filamentous fungal cells because they are easier to manipulate.

Bacteria from the genus Bacillus are very suitable as heterologous hosts because of their capability to secrete proteins into the culture medium. Other bacteria suitable as hosts are those from the genera Streptomyces and Pseudomonas. A preferred yeast host cell for the expression of the DNA sequence encoding the polypeptide is one of the genus Saccharomyces, Kluyveromyces, Hansenula, Pichia, Yarrowia, or Schizosaccharomyces. More preferably, a yeast host cell is selected from the group consisting of the species Saccharomyces cerevisiae, Kluyveromyces lactis (also known as Kluyveromyces marxianus var. lactis), Hansenula polymorpha, Pichia pastoris, Yarrowia lipolytica, and Schizosaccharomyces pombe.

Most preferred for the expression of the DNA sequence encoding an oxidase is, however, filamentous fungal host cells. Preferred filamentous fungal host cells are selected from the group consisting of the genera Aspergillus, Trichoderma, Fusarium, Chrysosporium, Disporotrichum, Penicillium, Acremonium, Neurospora, Thermoascus, Myceliophtora, Sporotrichum, Thielavia, and Talaromyces. More preferably a filamentous fungal host cell is of the species Aspergillus oyzae, Aspergillus sojae or Aspergillus nidulans or is of a species from the Aspergillus niger Group (as defined by Raper and Fennell, The Genus Aspergillus, The Williams & Wilkins Company, Baltimore, pp 293-344, 1965). These include but are not limited to Aspergillus niger, Aspergillus awamori, Aspergillus tubigensis, Aspergillus aculeatus, Aspergillus foetidus, Aspergillus nidulans, Aspergillus japonicus, Aspergillus oryzae and Aspergillus ficuum, and also those of the species Trichoderma reesei, Fusarium graminearum, Fusarium venenatum, Chrysosporium lucknowense, Penicillium chrysogenum, Acremonium alabamense, Neurospora crassa, Myceliophtora thermophilum, Sporotrichum cellulophilum, Disporotrichum dimorphosporum and Thielavia terrestris.

Examples of preferred expression hosts are fungi such as Aspergillus species (in particular those described in EP-A-184,438 and EP-A-284,603) and Trichoderma species; bacteria such as Bacillus species (in particular those described in EP-A-134,048 and EP-A-253,455), especially Bacillus subtilis, Bacillus licheniformis, Bacillus amyloliquefaciens, Pseudomonas species; and yeasts such as Kluyveromyces species (in particular those described in EP-A-096,430 such as Kluyveromyces lactis and in EP-A-301,670) and Saccharomyces species, such as Saccharomyces cerevisiae.

Host cells include plant cells, and the invention therefore extends to transgenic organisms, such as plants and parts thereof, which contain one or more cells of the invention. The cells may heterologously express one of the oxidases as described herein or may heterologously contain one or more of the polynucleotides as mentioned herein. The transgenic (or genetically modified) plant may therefore have inserted (typically stably) into its genome a sequence encoding the polypeptides as described herein. The transformation of plant cells can be performed using known techniques, for example using a Ti or a Ri plasmid from Agrobacterium tumefaciens. The plasmid (or vector) may thus contain sequences necessary to infect a plant, and derivatives of the Ti and/or Ri plasmids may be employed.

The host cell may over-express the polypeptide, and techniques for engineering over-expression are well known and can be used for the purpose of the present invention. The host may thus have two or more copies of the polynucleotide.

Alternatively, direct infection of a part of a plant, such as a leaf, root or stem can be effected. In this technique the plant to be infected can be wounded, for example by cutting the plant with a razor, puncturing the plant with a needle or rubbing the plant with an abrasive. The wound is then inoculated with the Agrobacterium. The plant or plant part can then be grown on a suitable culture medium and allowed to develop into a mature plant. Regeneration of transformed cells into genetically modified plants can be achieved by using known techniques, for example by selecting transformed shoots using an antibiotic and by sub-culturing the shoots on a medium containing the appropriate nutrients, plant hormones and the like.

Culture of Host Cells and Recombinant Production

The invention also describes cells that have been modified to express the glucose oxidase or a variant thereof. Such cells include transient, or preferably stably modified higher eukaryotic cell lines, such as mammalian cells or insect cells, lower eukaryotic cells, such as yeast and filamentous fungal cells or prokaryotic cells such as bacterial cells.

It is also possible for the oxidases to be transiently expressed in a cell line or on a membrane, such as for example in a baculovirus expression system. Such systems, which are adapted to express the oxidases, are also included within the scope of the present invention.

The production of the polypeptide as described herein can be effected by the culturing of microbial expression hosts, which have been transformed with one or more polynucleotides, in a conventional nutrient fermentation medium.

The recombinant host cells may be cultured using procedures known in the art. For each combination of a promoter and a host cell, culture conditions are available which are conducive to the expression the DNA sequence encoding the polypeptide. After reaching the desired cell density or titer of the polypeptide the culturing is ceased and the polypeptide is recovered using known procedures.

The fermentation medium can comprise a known culture medium containing a carbon source (e.g. glucose, maltose, molasses, etc.), a nitrogen source (e.g. ammonium sulfate, ammonium nitrate, ammonium chloride, etc.), an organic nitrogen source (e.g. yeast extract, malt extract, peptone, etc.) and inorganic nutrient sources (e.g. phosphate, magnesium, potassium, zinc, iron, etc.). Optionally, an inducer (dependent on the expression construct used) may be included or subsequently be added.

The selection of the appropriate medium may be based on the choice of expression host and/or based on the regulatory requirements of the expression construct. Suitable media are well-known to those skilled in the art. The medium may, if desired, contain additional components favoring the transformed expression hosts over other potentially contaminating microorganisms. Specifically for glucose oxidase, a medium lacking glucose, but instead using a different carbon-source such as fructose may be used.

The fermentation may be performed over a period of from 0.5-30 days. Fermentation may be a batch, continuous or fed-batch process, at a suitable temperature in the range of between 0° C. and 45° C. and, for example, at a pH from 2 to 10. Preferred fermentation conditions include a temperature in the range of between 20° C. and 37° C. and/or a pH between 3 and 9. The appropriate conditions are usually selected based on the choice of the expression host and the protein to be expressed.

After fermentation, if necessary, the cells can be removed from the fermentation broth by means of centrifugation or filtration. After fermentation has stopped or after removal of the cells, an oxidase may then be recovered and, if desired, purified and isolated by conventional means. A glucose oxidase can be purified from fungal mycelium or from the culture broth into which the glucose oxidase is released by the cultured fungal cells.

Modifications of Oxidases

The oxidases described herein may be chemically modified, e.g. post-translationally modified. For example, they may be glycosylated (one or more times) or comprise modified amino acid residues. They may also be modified by the addition of histidine residues to assist their purification or by the addition of a signal sequence to promote secretion from the cell. The oxidases may have amino- or carboxyl-terminal extensions, such as an amino-terminal methionine residue, a small linker peptide of up to about 20-25 residues, or a small extension that facilitates purification, such as a poly-histidine tract, an antigenic epitope or a binding domain.

An oxidase may be labelled with a revealing label. The revealing label may be any suitable label which allows the polypeptide to be detected. Suitable labels include radioisotopes, e.g. 125I, 35S, enzymes, antibodies, polynucleotides and linkers such as biotin.

The oxidases may be modified to include non-naturally occurring amino acids or to increase the stability of the polypeptide. When the proteins or peptides are produced by synthetic means, such amino acids may be introduced during production. The proteins or peptides may also be modified following either synthetic or recombinant production.

The oxidases may also be produced using D-amino acids. In such cases the amino acids will be linked in reverse sequence in the C to N orientation. This is conventional in the art for producing such proteins or peptides.

A number of side chain modifications are known in the art and may be made to the side chains of the oxidases. Such modifications include, for example, modifications of amino acids by reductive alkylation by reaction with an aldehyde followed by reduction with NaBH4, amidination with methylacetimidate or acylation with acetic anhydride.

The sequences described herein may also be used as starting materials for the construction of “second generation” enzymes. “Second generation” glucose oxidases are glucose oxidases, altered by mutagenesis techniques (e.g. site-directed mutagenesis or gene shuffling techniques), which have properties that differ from those of wild-type glucose oxidase or recombinant glucose oxidase such as those produced by the present invention. For example, their temperature or pH optimum, specific activity, substrate affinity or thermostability may be altered so as to be better suited for use in a particular process.

Amino acids essential to the activity of oxidase, and therefore preferably subject to substitution, may be identified according to procedures known in the art, such as site-directed mutagenesis or alanine-scanning mutagenesis. In the latter technique mutations are introduced at every residue in the molecule, and the resultant mutant molecules are tested for biological activity (e.g. glucose oxidase activity) to identify amino acid residues that are critical to the activity of the molecule. Sites of enzyme-substrate interaction can also be determined by analysis of crystal structure as determined by such techniques as nuclear magnetic resonance, crystallography or photo-affinity labelling.

Gene shuffling techniques provide a random way to introduce mutations in a polynucleotide sequence. After expression the isolates with the best properties are re-isolated, combined and shuffled again to increase the genetic diversity. By repeating this procedure a number of times, genes that code for vastly improved proteins can be isolated. Preferably the gene shuffling procedure is started with a family of genes that code for proteins with a similar function. The family of polynucleotide sequences provided with this invention would be well suited for gene shuffling to improve the properties of secreted oxidases.

Alternatively classical random mutagenesis techniques and selection, such as mutagenesis with NTG treatment or UV mutagenesis, can be used to improve the properties of a protein. Mutagenesis can be performed directly on isolated DNA, or on cells transformed with the DNA of interest. Alternatively, mutations can be introduced in isolated DNA by a number of techniques that are known to the person skilled in the art. Examples of these methods are error-prone PCR, amplification of plasmid DNA in a repear-deficient host cell, etc.

The use of yeast and filamentous fungal host cells is expected to provide for post-translational modifications (e.g. proteolytic processing, myristilation, glycosylation, truncation, and tyrosine, serine or threonine phosphorylation) as may be needed to confer optimal biological activity on recombinant oxidase products.

Preparations

Oxidases as described herein may be in an isolated form. It will be understood that the oxidase may be mixed with carriers or diluents which will not interfere with the intended purpose of the oxidase and still be regarded as isolated. An oxidase may also be in a substantially purified form, in which case it will generally comprise the polypeptide in a preparation in which more than 70%, e.g. more than 80%, 90%, 95%, 98% or 99% of the proteins in the preparation is a particular oxidase.

Oxidases may be provided in a form such that they are outside their natural cellular environment. Thus, they may be substantially isolated or purified, as discussed above, or in a cell in which they do not occur in nature, for example a cell of other fungal species, animals, plants or bacteria.

Detection and Isolation of Coding Genes

A peptide motif can be used to identify genes that code for proteins containing this peptide motif. Instead of one peptide motif, also a combination of two or more peptide motifs can be used to identify genes coding for proteins containing the peptide motifs. When one or several peptide motifs coding for specific (glucose) oxidases are identified it is thus possible to identify genes coding for (glucose) oxidases using one or a combination of several of these peptide motifs. A peptide motif can be used for a search in translated DNA sequences from a DNA databank or protein sequences from a protein sequence databank using a program like Patscan (http://www-unix.mcs.anl.gov/compbio/PatScan/HTML/). The amino acid sequence has to be entered in a special format that is described on the website. Another method that can be performed is to use the sequence of the motif for a search in translated DNA sequences from a DNA databank or protein sequences from a protein sequence databank using a program like http://myhits.isb-sib.ch/cgi-bin/. For this program the motif is entered in the search field in the so called Prosite format, and databases are searched for the presence of the motif in the protein sequence or in the translated DNA sequence. This method can be used to identify fungal genes that encode useful (glucose) oxidases. The genes that are identified using one of these methods can than be translated into a protein sequence using programs known to those skilled in the art, and be inspected for the presence of a signal sequence at their amino-terminus. For detecting a signal sequence one can use a program like SignalP (http://www.cbs.dtu.dk/services/SignalP/). Looking for a protein sequence that contains both the consensus sequences and a predicted signal sequence gives a large advantage for the industrial production of such an enzyme.

Another possibility to identify (glucose) oxidase genes using peptide motifs is to design oligonucleotide primers based on the back-translation of the amino acid sequence of the motif into a nucleotide sequence with preferred codon usage from the organism in which one wants to identify a glucose oxidase gene, and using this oligonucleotide for hybridization to a gene library, or in a PCR primer on a reverse transcribed mRNA pool. Using a peptide sequence motif, it is also possible to isolate genes encoding (glucose) oxidase when the gene sequence is unknown. Methods have been described in literature to design degenerate oligonucleotide primers that can be used for this purpose (Sambrook et al. (1989) Molecular cloning: a laboratory manual. Cold Spring Harbor Laboratory Press). Also, methods to isolate genes from an organism, using a degenerate oligonucleotide as probe or primer, have been described.

Oligonucleotides that code for the peptide motif are useful for isolation of the genes encoding (glucose) oxidase properties. The degeneracy of such a group of oligonucleotides may be decreased by the introduction of inosine (I) bases at positions where the nucleotide is not known. Additionally, positions where both cytosine (C) and thymidine (T) bases are possible may be replaced by uracil (U), and at positions where both adenine (A) and guanine (G) are possible only guanine may be introduced, in order to decrease degeneracy with only a small effect on specificity of the oligonucleotide primer. Furthermore, for screening the presence of genes encoding glucose oxidases in organisms of which the codon preference is known, the degeneracy of the oligonucleotide can be further decreased by taking the codon preference into account in the design of the oligonucleotide. A person skilled in the art will know how to do this. Furthermore, all possible combinations of oligonucleotide primers, without degeneracy, may be synthesized separately and used in individual screening experiments.

First, a genomic, cDNA or EST library is constructed from the species of interest in a universal vector. Suitable methods for library construction are described in literature (Sambrook et al. (1989) Molecular cloning: a laboratory manual. Cold Spring Harbor Laboratory Press). Second, a degenerate oligonucleotide described above is used in a PCR reaction together with one universal oligonucleotide that primes in the vector, at the border of the recombinant DNA insert, on DNA isolated from the library. Useful strategies have been described in literature for the isolation of a desired gene when only a single degenerate oligonucleotide primer is available (e.g. Minambres et al. (2000) Biochem. Biophys. Res. Commun. 272, 477-479; PCR technology (1989) Ed. H. A. Erlich pp. 99-104, Stockton Press). Third, the PCR amplified fragment is then labeled and used as probe for the screening of the library by conventional means. The full length gene can than be sub-cloned into an expression vector suitable for over-expression of the (glucose) oxidase in a desired production host organism.

In a different approach, when no library is available from the species that is screened for the presence of a gene encoding a (glucose) oxidase, part of the gene can be amplified by PCR with different degenerate primers, or with 3′-RACE using a single degenerate primer. For this, RNA is isolated from the species of interest and used in a 3′-RACE reaction using a single degenerate primer as gene specific primer. The amplification of part of an unknown cDNA using one degenerate oligonucleotide and one universal primer, by 3′-RACE, has been described previously (WO99/38956).

The traditional method to isolate a full-length gene using the information from only a small peptide is hybridization of a labeled degenerate oligonucleotide to filters on which a library is replicated. Methods describing the screening of gene libraries using degenerate oligonucleotides, and methods to calculate or determine the optimal hybridization conditions of these oligonucleotides, have been extensively described in literature (Sambrook et al.(1989)). The oligonucleotides described above may be used for this method to isolate genes encoding a glucose oxidase from different species.

In a variation to this method, a partial gene library can be constructed first. For this, DNA is fractionated, after which fragments of DNA containing the gene coding for a(n) (glucose) oxidase are detected by hybridization to the labeled oligonucleotides described above. These fragments are isolated and used in the construction of a partial gene library enriched in the gene coding for a(n) (glucose) oxidase. This library can than be screened by conventional means. For this method, genomic DNA is first digested with restriction enzymes before fractionation by gel-electrophoresis, while cDNA can be fractionated directly.

A different method to isolate the gene coding for a glucose oxidase is by using antibodies raised against any of the peptides of the consensus sequence. Antibodies may be monoclonal or polyclonal. Methods describing the production of antibodies specific for small peptides have been extensively described in literature (Harlow, E and Lane, D (1988) Antibodies; a laboratory manual, ISBN 0-87969-314.-2).

Expression libraries can be constructed from the species of interest, by cloning cDNA or genomic DNA into a vector suitable for expressing the insert in a convenient host, such as E. coli or yeast. Expression vectors may or may not be based on phage lambda. Immuno-detection of antigens produced by expression libraries, and methods describing the purification of specific clones expressing the antigen has been published. Using an antibody specific for any of the peptides of the consensus motif, it is possible to isolate the gene encoding a(n) (glucose) oxidase encompassing this motif, using this method.

In effect, many different methods may be used to isolate a gene coding for a(n) (glucose) oxidase when the information described in this invention is taken into account. The advantage of using the peptide motif sequence information over prior art methods is the speed and relative ease with which a new gene coding for an active (glucose) oxidase can be identified.

In a preferred embodiment, the invention provides method for preparing sheetable dough comprising adding an amount of water and an effective amount of oxidase to flour and wherein said amount of water in the absence of said oxidase results in a dough that can not be processed due to its stickiness, wherein said oxidase is a glucose oxidase from Aspergillus (referred to as AspGOX), a glucose oxidase from Penicillium (referred to as PenGOX) or an oxidase from Aspergillus which oxidase has at least 45% amino acid identity with an isoamylalcoholoxidase (referred to as ZLR or oxi 01) or any combination thereof. A suitable combination is AspGOX and PenGOX or AspGOX and ZLR or PenGOX and ZLR or AspGOX, PenGOX and ZLR.

Preferably the (total) amount of oxidase added in a method according to the invention is an effective amount. The skilled person is very well capable of determining what an effective amount is. The amount of enzyme used in the experimental part is 100 ppm (100 mg/kg) of a 1500 U/g batch, i.e. 150 U/kg. However, a method according to the invention is not restricted to this particular amount of an oxidase. Typically, a method according to the invention uses 50-185 U/kg (of flour), preferably 60-180 U/kg, more preferably 70-175 U/kg. A skilled person is very well capable of determining a (range of) effective oxidase amount.

In a preferred embodiment, the present invention provides a method for preparing sheetable dough comprising adding an amount of water and an effective amount of oxidase to flour and wherein said amount of water in the absence of said oxidase results in a dough that can not be processed due to its stickiness (or any of the alternative described wordings), wherein said dough is noodle dough, preferably asian noodle dough. Asian noodles can typically be divided into Chinese type noodles and Japanese type noodles. Chinese type noodles are generally made from hard wheat flour, characterized by bright creamy white or bright yellow colour and firm texture. Japanese type noodles are typically made from soft wheat flour of medium protein content and have a creamy white colour and a soft and elastic texture.

In general, all noodles contain wheat flour, water and salt. Typically, about three parts of flour are usually mixed with on part of salt or alkaline salt. Hence, in a preferred embodiment, the invention provides a method for preparing sheetable dough comprising adding an amount of water and an effective amount of oxidase to flour and wherein said amount of water in the absence of said oxidase results in a dough that can not be processed due to its stickiness, further comprising adding salt to the flour.

Examples of suitable salts are sodium chloride (white noodles) or kan suiu, a mixture of sodium and potassium carbonates (yellow noodles). The use of alkaline salts in noodle manufacture can be quite variable. Therefore, while yellow (alkaline) noodles are typically made with an alkaline salts level of up to 2%, typically 1.5 or 1%, but sometimes as low as 0.5%, white noodles are made without alkaline salts, or with low levels, such as 0.1%, 0.2% or 0.3%.

Instant noodles usually contain a hydrocolloid, for example guar gum, making the noodles firmer and easier to rehydrate upon cooking or soaking. The invention thus also provides a method for preparing sheetable dough comprising adding an amount of water and an effective amount of oxidase to flour and wherein said amount of water in the absence of said oxidase results in a dough that can not be processed due to its stickiness, further comprising adding a hydrocolloid, preferably guar gum, to the flour. Other suitable hydrocolloids are gums and polysaccharides, such as but not limited to Locust Bean Gum, Carrageenan, Agar, Pectin, Starch, Modified Starch, gelatin, alginate, xanthan or gum arabic.

Polyphosphates may be used to allow more water retention on the noodles surface giving better mouth-feel. Yet another example of an additive is starch which is used in the preparation of some types of instant noodles. A further example of an additive is egg.

As described in detail in the examples, a dough obtainable according to a method of the invention has particular good processability features, such as a good sheetability.

In yet another embodiment, the invention therefore provides a dough obtainable from dough prepared by a method of the invention, i.e. a method for preparing sheetable dough comprising adding an amount of water and an effective amount of oxidase to flour and wherein said amount of water in the absence of said oxidase results in a dough that can not be processed due to its stickiness (or by any of the alternatively worded methods).

Said dough can be distinguished from other doughs by its water absorption level and/or the presence of glucose oxidase. The invention therefore also provides a dough characterised in that the water level is above the maximal water addition level based on the starting flour. The presence of an oxidase can for example be detected by performing an activity assay or by using an LC-MS analysis.

The dough obtainable according to a method as described herein can be used to prepare noodles, wrappings or dumpling or any other dough product wherein the dough needs a processing step such as sheeting or rolling. As described within the experimental part, noodles prepared with the obtained dough have some advantageous features such as improved elasticity and smoothness. The textural and sensory properties of cooked noodles can for example be determined by a trained sensory panel, using the following scoring system: Appearance (0-10, where 0 is described as “dull pale” and 10 as “bright creamy”), Smoothness (0-10, where 0 is low degree of smoothness and 10 is high degree of smoothness), Firmness (0-10, where 0 is soft and 10 is firm), Elasticity (0-10, where 0 is low degree of elasticity and 10 is high degree of elasticity) and Taste and Flavor (0-10, where 0 is intense taste and flavor, and 10 is slight taste and flavor).

Noodle strands may be assessed after cooking for maximum cutting stress and elasticity index by using a texture analyzer, such as the Ta-XT2 analyzer (Texture Technologies, Scarsdale, N.Y., USA). Useful settings for this analysis are: pre-test speed 2.0 mm/sec, test speed 0.2 mm/sec; post-test speed 1.0 mm/sec, trigger force 5 g.

The desired features such as elasticity and smoothness were especially present in noodles which have no or very low level of alkaline salt (for example 0.1-0.2% or any value in between) in their formulations, such as (cooked) instant noodles or more specific steamed and deep-fried instant noodles.

Steamed and deep-fried noodles are partially cooked by steaming and further cooked and dehydrated by a deep-frying process. The cut noodle strands are continually fed into a traveling net conveyor moving slower than the cutting rolls above it. The speed differential between noodle feeding and net traveling creates a unique wave in the noodle strands. The cut and wavy noodle strands are then cooked with steam while passing through a tunnel steamer. After steaming, noodles are extended to separate the strands and cooled with a cooling fan. Noodles are then cut into a predetermined length to make one serving size. The noodle strands may be folded to form a double layer of noodle blocks. The blocks are then distributed into baskets, which are mounted on the traveling chain of a tunnel fryer. The noodle blocks and baskets are immersed in hot oil for deep-frying. As noodles come out of the fryer, their temperature may be as high as 160° C. They require immediate cooling to avoid rapid oil oxidation. At the same time, excess oil is drained away. Fried noodles are cooled to room temperature in a travelling cooling tunnel with fans on the top. The cooled noodles and soup-base sachets are automatically packed.

There are two types of steamed and deep-fried instant noodles available in the market based on packaging—polyethylene bag-packed or Styrofoam bowl-packed. Bag-packed noodles are usually cooked in constantly boiling water for about 3-4 minutes before serving, and the bowl-packed or ‘cup’ of noodles are ready to serve after pouring hot water into the bowl and resting for 2-3 minutes. The noodle strands of bowl-type noodles are usually thinner than the bag-type to facilitate the rehydration rate. The basic processing procedures for bag- and bowl-type noodles are similar. There do exist, however, some differences in the processing of these two types of noodles. For example, up to 25 percent (based on flour weight) of potato starch is usually included in the formulation for bowl-type noodles and they are fried longer in hot oil than bag-type noodles.

In yet a further embodiment, the invention provides a method for producing noodles comprising dough obtainable a method for preparing sheetable dough comprising adding an amount of water and an effective amount of oxidase to flour and wherein said amount of water in the absence of said oxidase results in a dough that can not be processed due to its stickiness. In a preferred embodiment, said noodles are asian noodles and even more preferred are noodles which have no or very low level of alkaline salt in their formulation and most preferred said noodles are (steamed and deep-fried) instant noodles.

The invention further provides noodles obtainable by the last described method.

It is clear from the experimental part that such noodles have improved elasticity and/or smoothness and hence the invention further provides noodles characterised in that the elasticity is improved when compared to noodles the flour of which was not provided with an oxidase and a water absorption level above the (pre) determined maximal water absorption level and the invention also provides Noodles characterised in that the smoothness is improved when compared to noodles the flour of which was not provided with an oxidase and a water absorption level above the (pre) determined maximal water absorption level. In a preferred embodiment, said noodles are Asian noodles and even more preferred are noodles which have no or very low level of alkaline salt in their formulation and most preferred said noodles are (steamed and deep-fried) instant noodles.

The invention will be explained in more detail in the following detailed description which does not limit the invention.

### EXAMPLE 1

### Cloning and Expression of the Glucose Oxidase Gene ZGL (PenGOX)

Penicillium chrysogenum strain CBS 455.95 was grown for 3 days at 30 degrees Celsius in PDB (Potato dextrose broth, Difco) and chromosomal DNA was isolated from the mycelium using the Q-Biogene kit (catalog nr. 6540-600; Omnilabo International BV, Breda, the Netherlands), using the instructions of the supplier. This chromosomal DNA was used for the amplification of the coding sequence of the glucose oxidase gene using PCR.

To specifically amplify the glucose oxidase gene ZGL from the chromosomal DNA of Penicillium chrysogenum strain CBS 455.95, two PCR primers were designed. Primer sequences were partly obtained from a sequence that was found in the genomic DNA of Penicillium chrysogenum CBS 455.95 and is depicted in SEQ ID NO: 1. We found that this sequence has <70% identity with glucose oxidase sequences of Aspergillus niger. We describe here the efficient expression and characterization of a secreted Penicillium glucose oxidase. The protein sequence of the complete glucose oxidase protein, including potential pre- and pro-sequences is depicted in SEQ ID NO: 3. The advantage of the Penicillium enzyme compared to the Aspergillus homologue is that the Penicillium enzyme can be easily over-expressed and secreted in amounts that are relevant for applications in the food industry.

Zgl-dir
5′-CCCTTAATTAACTCATAGGCATCATGAAGTCCACTATTATCACCTC
Zgl-rev
5′-TTAGGCGCGCCCACTGTCGGGATGATCGACCA

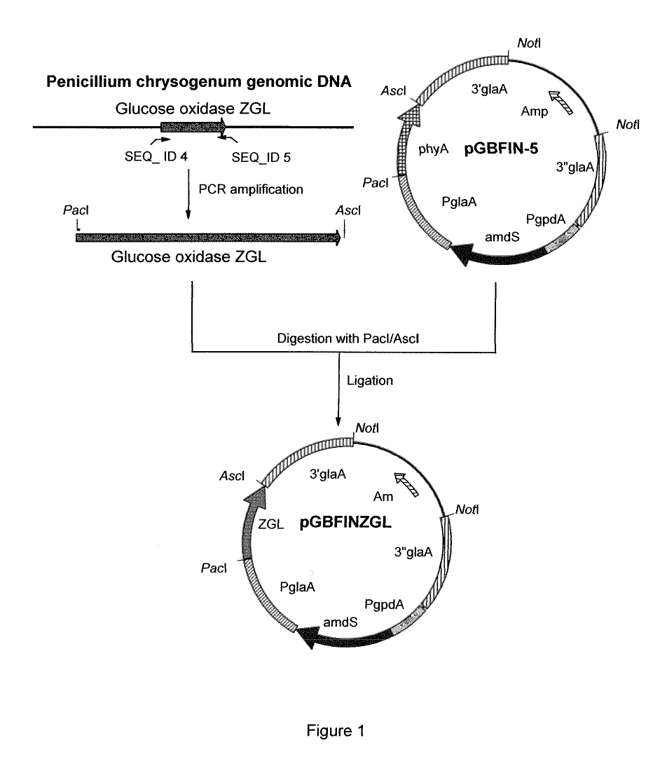

The first, direct PCR primer (ZGL-dir) contains 23 nucleotides ZJW coding sequence starting at the ATG start codon, preceded by a 23 nucleotides sequence including a PacI restriction site (SEQ ID NO:4). The second, reverse primer (ZGL-rev) contains nucleotides complementary to the reverse strand of the region downstream of the ZGL coding sequence preceded by an AscI restriction site (SEQ ID NO:5). Using these primers we were able to amplify a 1.9 kb sized fragment with chromosomal DNA from Penicillium chrysogenum strain CBS 455.95 as template. The thus obtained 1.9 kb sized fragment was isolated, digested with PacI and AscI and purified. The PacI/AscI fragment comprising the ZGL coding sequences was exchanged with the PacI/AscI phyA fragment from pGBFIN-5 (WO 99/32617). Resulting plasmid is the ZGL expression vector named pGBFINZGL (see FIG. 1). The expression vector pGBFINZGL was linearized by digestion with NotI, which removes all E. coli derived sequences from the expression vector. The digested DNA was purified using phenol:chloroform:isoamylalcohol (24:23:1) extraction and precipitation with ethanol. These vectors were used to transform Aspergillus niger CBS513.88. An Aspergillus niger transformation procedure is extensively described in WO 98/46772. It is also described how to select for transformants on agar plates containing acetamide, and to select targeted multicopy integrants. Preferably, A. niger transformants containing multiple copies of the expression cassette are selected for further generation of sample material. For the pGBFINZGL expression vector 30 A. niger transformants were purified; first by plating individual transformants on selective medium plates followed by plating a single colony on PDA (potato dextrose agar: PDB+1.5% agar) plates. Spores of two individual transformants were collected after growth for 1 week at 30 degrees Celsius. Spores were stored refrigerated and were used for the inoculation of liquid media.

The two A. niger transformant strains were used for generation of sample material by cultivation of the strains in shake flask cultures. A useful method for cultivation of A. niger strains and separation of the mycelium from the culture broth is described in WO 98/46772. Cultivation medium was in CSM-MES (150 g maltose, 60 g Soytone (Difco), 15 g (NH₄)₂SO₄, 1 g NaH₂PO₄.H₂O, 1 g MgSO₄.7H₂O, 1 g L-arginine, 80 mg Tween-80, 20 g MES pH6.2 per liter medium). 5 ml samples were taken from duplicate cultivations on day 4-8 of the fermentation, centrifuged for 10 min at 5000 rpm in a Hereaus labofuge RF and supernatants were stored at −20° C. until further analyses.

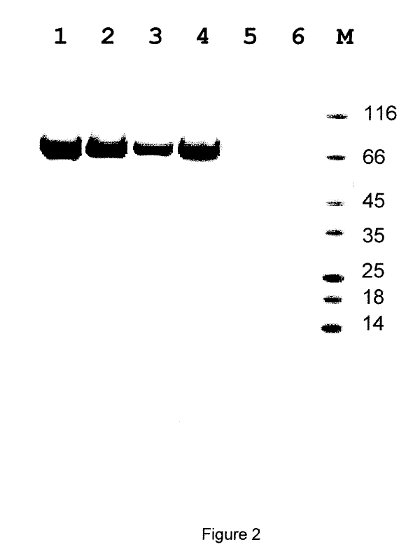

It became clear that the transformants containing the pGBFINZGL vector had a surprisingly efficient secretion of a protein of apparent molecular weight of approximately 70 kDa when analyzed with SDS-PAGE (FIG. 2). Since this is almost identical to the molecular weight that is predicted from the protein sequence of ZGL, we presume that after removal of the signal sequence almost no glycosylation takes place when Penicillium chrysogenum glucose oxidase ZGL is secreted from Aspergillus niger. This is in contrast to the Aspergillus niger glucose oxidase which is heavily glycosylated.

Selected strains can be used for isolation and purification of a larger amount of Penicillium glucose oxidase, when fermentation and down-stream processing is scaled up. This enzyme can than be used for further analysis, and for the use in diverse industrial applications, for example in a method as herein described.

### EXAMPLE 2

Fermentation, Purification, and Characterization of Glucose Oxidase ZGL from Penicillium chrysogenum, Expressed in Aspergillus niger.

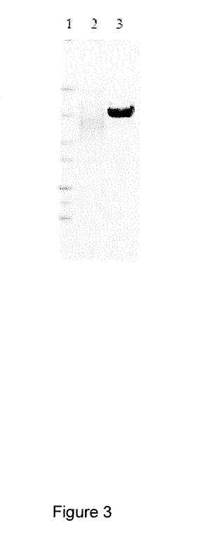

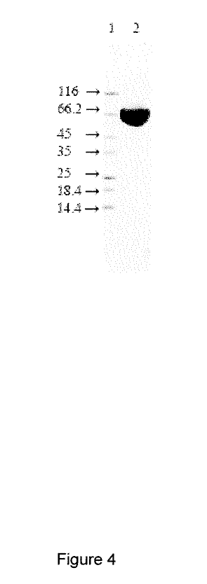

Fresh Aspergillus niger ZGL transformant #1 spores were used to inoculate shake flasks with 2 liters modified CSM medium (8% maltose, 3% bactosoytone, pH 5.1). After three days cultivation at 30° C., the cells were killed off by adding 3.5 g/l (final concentration) sodium benzoate and keeping at 30° C. for 6 hours. 10 g/l CaCl₂ and 45 g/l filter-aid Dicalite BF were added to the culture broth, and filtration was carried out in one step using filter cloth and filters Z-2000 and Z-200 (Pall). The filter cake remaining on the filter was washed with 1.2 liters of sterile milliQ water. The culture filtrate was sterile-filtered using 0.22 mm GP Express PLUS Membrane (Millipore). The ZGL expression after three days of cultivation in modified CSM medium is presented in FIG. 3. The sterile filtrate was concentrated by Ultrafiltration on a Pellicon XL Cassette Biomax5 (Millipore). The ultra-filtrate was purified with AIEX chromatography using a Q-sepharose XK 16/20 column (gel volume approx 30 ml). The following buffer system was used: Buffer A: 20 mM Na-phosphate, pH 8.2, Buffer B: 20 mM Na-phosphate, pH 8.2+1 M NaCl. The purification cycle was: equilibration with buffer A (5 cv); Loading of the sample; Washing with buffer A (3 cv); Gradient elution from buffer A to buffer B in 20 cv. Flow rate 5 ml/min. The eluate was retrieved in several fractions. The fractions with minor contaminations were pooled. The purity of the pooled sample was checked by SDS-gel electrophoresis (FIG. 4). This protein solution was used for subsequent activity determinations.

### Enzymatic Characterization.

Specific activity assays were performed with the Amplex Red Glucose Oxidase Assay kit (Invitrogen), with 100 mM D-glucose as substrate.

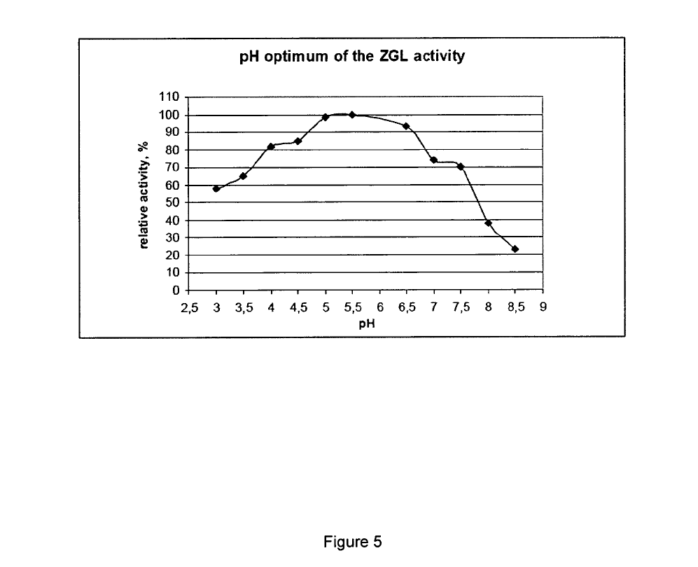

To determine the pH optimum, incubations of enzyme and substrate were performed in 50 mM buffer with the appropriate pH. Samples were diluted in Assay reaction buffer (pH=7.4) for detection of the reaction product by the Amplex Red kit. The buffers used were: pH=3.0-7.5:50 mM citrate-Na-phosphate buffer; pH=8.0-8.5:50 mM Tris-HCl, and the incubations were performed at 25° C. for 30 minutes. The results are shown in FIG. 5. The enzyme showed a pH optimum in the range 5-6.5, but on the whole showed a remarkable residual activity at much more extreme pH values. It is clear that the pH optimum of the enzyme is very broad.

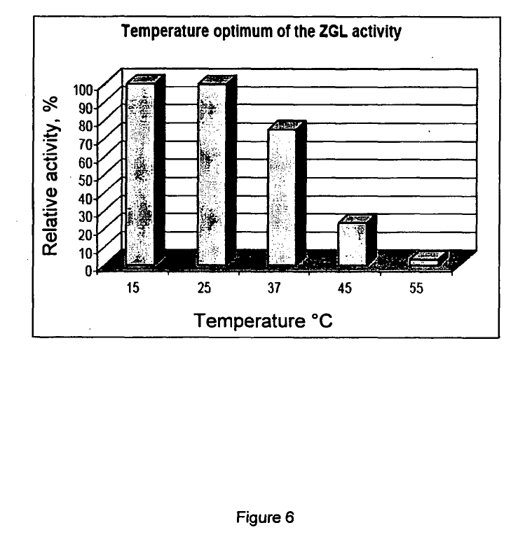

For testing the temperature tolerance, incubations were performed at 15, 25, 37, 45, and 55° C., pH 7.4, 30 min (FIG. 6). The highest values were obtained at lower temperatures.

### EXAMPLE 3

Preparation of Enzyme Solutions

Three oxidase enzymes were used for the use in noodle manufacturing tests: two glucose oxidase enzymes and the oxidase ZLR.

The first enzyme (GOX) was a commercial product obtained from DSM Food Specialties, with an enzyme strength of 1500 U/ml, where 1 U is the amount of enzyme that liberates 1 micromole of hydrogen peroxide in one minute at pH=5.9.

The second enzyme (ZGL) was a glucose oxidase from Penicillium chrysogenum, expressed and produced in Aspergillus niger (see example 2).

The activity was determined to be 573 U/ml.

The third enzyme (ZLR) is an oxidase, but not a sugar oxidase. It is active on wheat flour extracts, where 9,12,13-hydroxy-10-octadecanoic acid was identified as a substrate. However, the activity of the enzyme solution is difficult to quantify, since it is unknown whether the availability of substrates is limiting or not using different samples of flour. Therefore, this enzyme was dosed on the basis of its protein content.

Fresh Aspergillus niger ZLR527-2 spores were used to inoculate shake flasks with 2 liters modified CSM medium (8% maltose, 3% bactosoytone, pH 5.1). After three days cultivation at 30° C., the cells were killed off by adding 3.5 g/l (final concentration) sodium benzoate and keeping at 30° C. for 6 hours. 10 g/l CaCl2 and 45 g/l filter-aid Dicalite BF were added to the culture broth, and filtration was carried out in one step using filter cloth and filters Z-2000 and Z-200 (Pall). The filter cake remaining on the filter was washed with 1.2 liters of sterile milliQ water.

The culture filtrate was sterile-filtered using 0.22 mm GP Express PLUS Membrane (Millipore).

The sterile filtrate was concentrated by Ultrafiltration on a Pellicon XL Cassette Biomax5 (Millipore).

The ultra-filtrate was purified with AIEX chromatography using a Q-sepharose XK 16/20 column (gel volume approx 30 ml). The following buffer system was used:

Buffer A: 50 mM Na-acetate, pH 5.6

Buffer B: 50 mM Na-acetate, pH 5.6+1 M NaCl

The purification cycle was:

Equilibration with buffer A (5 cv)

Loading of the sample

Washing with buffer A (3 cv)

Gradient elution from buffer A to buffer B in 20 cv. Flow rate 5 ml/min.

The eluate was retrieved in several fractions. The fractions with minor contaminations were pooled. The purity of the pooled sample was checked by SDS-gel electrophoresis. The sample was concentrated by ultrafiltration, and the following agents were added: glycerol (to 50%), L-methionine (0.1%), Na-benzoate (0.1%) and CaCl₂ (0.02%). The protein concentration of this concentrate was 70 mg/ml.

### EXAMPLE 4

### Application of Glucose Oxidase in the Preparation of White Noodles

To measure the effect of oxidase enzymes on the water absorption and stickiness of noodle dough sheets, white salted noodle flour containing 2% NaCl was mixed with 100 ppm of GOX, or 300 ppm of the other enzymes.

The dough crumbs were rested for 30 minutes and then sheeted using sheeting rolls. The stickiness of the dough was measurements by a TA-TX2 texture analyzer, by measuring the energy required to separate a metal probe from the dough surface (area under the curve). The results are shown in Table 1 (moisture expressed as water addition in % (v/w) of the flour weight).

TABLE 1

| Type of | Water absorption | Properties without | Properties with |
|---|---|---|---|
| noodles | level | enzymes | enzymes |
| White salted | 32-34% (normal) | Good dough | Dough too dry |
| noodles 2% | | moisture | |
| NaCL | | | |
| | 36-38% (high) | Too sticky for | Good |
| | | automated | machinability |
| | | processing | |
| | 40% (very high) | Impossible to | Reasonable |
| | | process | machinability |

From the results it is clear that all three enzymes can be used to reduce stickiness in noodle dough with increased water content. Similar results were obtained when the resting time was shortened to 10 minutes.

The doughs with high water absorption levels were smoother and more homogeneous than the ones with lower water absorption levels. However, the doughs with increased water absorption made without an oxidase were too sticky to be processed.

### EXAMPLE 5

### Quality Aspects of Application of Glucose Oxidase

In general, the development of noodle dough is limited by its water content. About 32-34% moisture is the limit, above which the stickiness of the dough becomes too high for machinability. However, at these moisture levels it is clearly visible that the dough is not homogenenous. This lack of homogeneity gives rise to decreased quality in the final product.

Using oxidase enzymes at the same dosage level as described above, we have found that it is was possible to increase the water content of the dough, while maintaining excellent machinability. Two different types of noodles were prepared: (1) Fresh white salted noodles (2% NaCl in the dough) and (2) steamed and deep-fried instant noodles (1% NaCl+0.1% alkaline salts (1:1 mixture of sodium carbonate and potassium carbonate)+0.2% guar gum). The enzymes were added in the appropriate amount to 100 ml distilled water, and after 10 minutes added to the flour. The other components were dissolved in the remaining portion of the water (amount dependent on the moisture content of the dough—in this experiment 34 and 38% were used). The doughs were mixed for 10 minutes at 100 rpm in an Ohtake vertical mixer.

Subsequently, the doughs were sheeted on a pilot noodle line manufactured by Ohtake Noodel machine MFG. Co. of Japan. First two dough sheets (5.1 mm gap setting) were laminated (5.1 mm gap setting), and the resulting sheet was subsequently reduced in thickness by four reduction passes to a final gap setting of 1.0 mm.

Deep-fried instant noodles prepared from these doughs with increased water content, gave rise—after cooking—to a consumable product that showed better texture properties (higher elasticity, higher smoothness and lower firmness) than the low-moisture controls. There was also an improved resistance to over-cooking, and decreased loss of dry matter during cooking.

Also dried noodles prepared from doughs with increased water content, after cooking showed increased smoothness and lower firmness. With the high quality flour used in this work, the beneficial effect was relatively small. This may be attributed by the favorable effect of the drying procedure on the development of these strong flours. This effect is expected to be much stronger when flours with a lower content and quality of protein are used.

When fresh noodles were prepared with the same levels of oxidases, an interesting observation was made: during storage during a few hours, a rancid odor developed. This can be attributed to the oxidation of the oil present in the wheat flour, caused by the high activity of the (still-active) enzymes in this high-moisture system. However, at much lower dosages (10 or even 1 ppm for GOX, or 10 ppm for ZGL), the oxidases gave a marked improvement of the appearance of the fresh noodles without adverse effects on organoleptic quality. This effect was independent on the moisture level. After 24 hours enzyme-treated noodles looked as the untreated after 3 hours, and after 3 days as the untreated after 1 day.

### EXAMPLE 6

### Effect of Glucose Oxidase on Alkaline (Yellow) Noodle Sheets

To study whether glucose oxidases can also reduce stickiness in alkaline noodle dough with elevated water content, an alkaline noodle dough was prepared, with 1% NaCl and 1% alkaline salt blend (an 1:1 sodium and potassium carbonate mixture) instead of the 2% NaCl of the white noodle dough of the previous examples.

The glucose oxidase ZGL and the oxidase ZLR (at 300 ppm) were used as enzymes, on account of their favorable activity at high pH compared to the commercial GOX. The stickiness of the dough was measured using a TA-TX2 texture analyser.
The results are shown in Table 2:

TABLE 2

| | water % | | | | | | | |
|---|---|---|---|---|---|---|---|---|
| | 34% | | 36% | | 38% | | 40% | |
| +/− enzyme | — | ZGL | — | ZGL | — | ZGL | — | ZGL |
| stickiness | 37.6 | 37.1 | 55.5 | 51.2 | 69.7 | 64.8 | 80.3 | 69.5 |
| +/− enzyme | — | ZLR | — | ZLR | — | ZLR | — | ZLR |
| stickiness | 37.0 | 34.1 | 49.2 | 46.2 | 64.7 | 59.5 | 76.3 | 67.9 |

From the results it is clear that oxidases can be used to reduce stickiness in alkaline noodle dough with increased water content.

### EXAMPLE 7

### Application of Glucose Oxidase in the Preparation of White Noodles

To measure the effect of the Penicillium glucose oxidase (GOX) on the water absorption and stickiness of noodle dough sheets, white salted noodle flour containing 2% NaCl was mixed with 100 ppm of glucose oxidase. Two glucose oxidases were used: (1) A niger glucose oxidase (commercially available from DSM Food Specialties) and (2) the Penicillium glucose oxidase (penGOX) as described herein.

The dough crumbs were rested for 30 minutes and then sheeted using sheeting rolls. The stickiness of the dough was measurements by a TA-TX2 texture analyzer, by measuring the energy required to separate a metal probe from the dough surface (area under the curve). The results are shown in Table 3.

TABLE 3

| | Water absorption | Effect | |
|---|---|---|---|
| Type of noodles | level | A. niger GOX | Effect penGOX |
| White salted | 32-34% (normal) | Dough too dry | Dough too dry |
| noodles 2% NaCL | | | |
| | 36-38% (high) | Reduction of | Reduction of |
| | | stickiness | stickiness |

From the results it is clear that the glucose oxidases can be used reduce stickiness in noodle dough with increased water content. Similar results were obtained when the resting time was shortened to 10 minutes.

The doughs with high water absorption levels were smoother and more homogeneous than the ones with lower water absorption levels. However, the doughs with increased water absorption made without GOX enzyme were too sticky to be processed.

### EXAMPLE 8

### Application of the Glucose Oxidase in the Preparation of Yellow Noodles

To investigate whether the penGOX could also be applied in alkaline foods, 100 ppm of the enzyme was added to yellow noodles dough, containing 1% NaCl plus 1% alkaline salt (1:1 of sodium and potassium carbonate). A niger glucose oxidase was taken as a reference. The dough crumbs were rested for 30 minutes and then sheeted using sheeting rolls. The stickiness of the dough was measurements by a texture analyzer. The results are shown in Table 4.

TABLE 4

| | water | | |
|---|---|---|---|
| | absorption | | |
| Type of noodles | level | Effect A. niger GOX | Effect penGOX |
| Yellow noodles 1% | 34-36% | Not sticky | Too dry |
| NaCl + 1% alkaline | | | |
| salt (1:1 Na and K | | | |
| carbonate) | | | |
| | 38-40% | No reduction of | Reduction of |
| | | stickiness | stickiness |

From the results it is clear that the penGOX can be used in applications in which the conventionally used A. niger glucose oxidase cannot be used. Similar results were obtained when the resting time was shortened to 10 minutes.

In general, the development of noodle dough is limited by its water content. About 32-34% moisture is the limit, above which the stickiness of the dough becomes too high for machinability. However, at these moisture levels it is clearly visible that the dough is not homogenenous. This lack of homogeneity gives rise to decreased quality in the final product.

Using glucose oxidases with the right activity profile, we have found that it is possible to increase the water content of the dough, while maintaining excellent machinability. This was found for both the A. niger glucose oxidase and the penGOX in white salted noodles, and for the penGOX in yellow alkaline noodles.

Noodles prepared from these doughs with increased water content, showed better texture properties, resistance to over-cooking, and decreased loss of dry matter during cooking. In the case of fried instant noodles, also a lower absorption of the frying oil was observed.

1. A method for preparing sheetable dough comprising adding an amount of water and an effective amount of oxidase to flour and wherein said amount of water in the absence of said oxidase results in a dough that can not be processed due to its stickiness.

2. A method according to claim 1, further comprising (pre)determining the maximal water addition level based on the starting flour and wherein said added amount of water is above the determined maximal water addition level.

3. A method according to claim 2, wherein said amount of water is 1 to 6% above the maximal water addition level.

4. A method according to claim 1, wherein said oxidase is a glucose oxidase or an oxidase having at least 45% identity to an isoamylalcoholoxidase.

5. A method according to claim 1, wherein said dough is noodle dough, preferably asian noodle dough.

6. A method according to claim 1, further comprising adding salt to the flour.

7. A method according to claim 1, further comprising adding a hydrocolloid, preferably guar gum, to the flour.

8. A dough obtainable by the method according to claim 1.

9. A dough characterised in that the water level is above the maximal water addition level based on the starting flour.

10. A method for producing noodles comprising dough according to claim 8.

11. Noodles obtainable by the method according to claim 10.

12. Noodles characterised in that the elasticity is improved when compared to noodles the flour of which was not provided with an oxidase and a water addition level above the (pre) determined maximal water addition level.

13. Noodles characterised in that the smoothness is improved when compared to noodles the flour of which was not provided with an oxidase and a water addition level above the (pre) determined maximal water addition level.

14. Noodles according to claim 11, which are asian noodles.

15. Noodles according to claim 11, which are instant noodles.
